(19) United States
(12) Patent Application Publication
(10) Pub. No.: US 2017/0066597 A1
(43) Pub. Date: Mar. 9, 2017

(54) INFORMATION PROCESSING DEVICE, INFORMATION PROCESSING SYSTEM, DISTRIBUTION SYSTEM, INFORMATION PROCESSING METHOD, AND PROGRAM STORAGE MEDIUM

(71) Applicant: NEC Corporation, Minato-ku, Tokyo (JP)

(72) Inventor: Noriyoshi HIROI, Tokyo (JP)

(73) Assignee: NEC Corporation, Minato-ku, Tokyo (JP)

(21) Appl. No.: 15/120,827

(22) PCT Filed: Feb. 27, 2015
(86) PCT No.: PCT/JP2015/001029

§ 371 Date: Aug. 23, 2016

(30) Foreign Application Priority Data
Mar. 28, 2014 (JP) 2014-067358

(51) Int. Cl. B65G 43/08; B65G 15/00; G05B 15/02

(52) U.S. Cl. CPC B65G 43/08; G05B 15/02; B65G 15/00

(57) ABSTRACT

In order to achieve improved work efficiency and reduced work errors, this information processing device is provided with an acquisition unit, a detection unit, and a report control unit. The acquisition unit acquires information used in work to be executed on a work object from a document attached to the work object. The detection unit detects the whereabouts of the work object. On the basis of a rule that is data in which the information used in the work and work contents utilizing the information are associated with each other, the report control unit detects the work contents for the work object. Further, the report control unit reports the work contents by controlling a report device for reporting the work contents.

### TECHNICAL FIELD

The present invention relates to a technique capable of improving the efficiency of shipping operations in distribution businesses, manufacturers and the like, and sorting operations in retail businesses and the like.

### BACKGROUND ART

A plurality of dimensions, kinds or destinations (addresses) of parcels or items handled in physical distribution warehouses of distributors, manufacturers, stores, online retail stores and the like are various. An operation (hereinafter referred to as a sorting operation) of sorting parcels and items according to a delivery destination or the kind of packages is performed in the following order. For example, first, an operator reads a destination label of a parcel or an item (hereinafter referred to as a sorting object) placed on a working table. Subsequently, the operator moves sorting objects to a storage rack, a roll box pallet, or the like according to a delivery destination or the kind of packages based on information described in the destination label.

In a general sorting operation, since sorting objects are sequentially supplied to the working table by a machine such as a belt conveyor or a sorter, a sorting object is always present on the working table. Moreover, since the operator can freely move the sorting object on the working table with his or her hands, it is possible to save the labor of the sorting operation according to a plan of the operator. For example, the operator sorts sorting objects collectively. The operator moves and turns to such a position and in such a direction that the operator can easily carry the sorting object and then lifts the sorting object. The operator moves sorting objects on the working table collectively to a position near a sorting destination and then lifts the sorting objects. With such an operation, the operator can save the labor of the sorting operation. Further, in the sorting operation, for example, in case that a plurality of operators determines a sorting destination (a storage rack, a roll box pallet, or the like) to which each operator is allocated and moves the sorted sorting objects to the allocated sorting destination, it is possible to decrease the walking distance of each operator. Moreover, in case that a plurality of operators performs the sorting operation and an operator who is not busy assists other operators, it is possible to improve the efficiency of the sorting operation. That is, the sorting operation period is different depending on an operator or a sorting object. Even when an operator is behind with operations, another operator who is not busy assists the operator. In this way, it is possible to perform the sorting operation efficiently as a whole.

The sorting operation can be automated using machines such as a belt conveyor having a sorter function or a pickup robot in case that types and destinations of sorting objects are limited as in libraries or shipping sites of producers who manufacture a small variety of products. However, since the apparatus that automates the sorting operation is expensive, has low versatility, and requires large facility, distributors and retailers who can introduce such the apparatus are limited. Thus, most sorting operations are performed by manpower without using such the apparatus.

PTL 1 discloses a technique related to the sorting operation. In the technique of PTL 1, information on a sorting destination read by a business terminal such as a hand scanner from a radio frequency identifier (RFID), a barcode, or a two-dimensional code provided on a sorting object is notified to an operator. According to this technique, since the sorting destination which is the minimum information necessary in a sorting place is notified to the operator, the operator can perform the sorting operation without the need to understand or recognize the sorting destination.

PTL 2 discloses a technique of displaying destinations of individual sorting objects placed on a belt conveyor on a display device. According to this technique, since the visibility of the sorting object is improved, it is possible to decrease sorting errors and to improve the accuracy of the sorting operation.

PTL 3 discloses a technique related to an automated warehouse in which loading, storage, and unloading of items and parcels into and from a warehouse are controlled by a combination of a plurality of robots and conveyors. According to this technique, it is possible to improve the loading and unloading efficiency in a warehouse.

Moreover, PTL 4 discloses a technique of reading the content of a slip attached to an upper surface of a parcel regardless of the size of the parcel without increasing the scale of facility in a delivery center or the like in which various parcels of different sizes are handled. Further, PTL 5 discloses a technique of easily extracting an intended article from articles being conveyed by a belt conveyor.

### CITATION LIST

### Patent Literature

[PTL 1] JP 3867970 B2
[PTL 2] JP 2011-102170 A
[PTL 3] JP 3484104 B2
[PTL 4] JP 2006-155395 A
[PTL 5] JP 2008-280102 A

### SUMMARY OF INVENTION

### Technical Problem

However, in case that the technique disclosed in PTL 1 is used, an operator has to hold the sorting object and the business terminal in a switched manner and look at the sorting object and the display alternately. Thus, the sorting operation which uses the technique disclosed in PTL 1 is not efficient. Moreover, in the technique of PTL 1, the display of the scanner or an auxiliary display for displaying the sorting destination is disposed at a position away from the sorting object. In this case, since the sorting object being sorted by the operator may be different from the sorting object relating to the information of the sorting destination displayed on the display, the operator may recognize the sorting destination wrongly.

In case that the technique disclosed in PTL 2 is used, it is necessary to adjust the speed of the belt conveyor according to an operation period of the operator. That is, the speed of the belt conveyor and the overall operation speed are determined by an operation which takes the largest period. Thus, even when the operator completes the operation faster than the speed, the operator has to wait for the next sorting object without moving onto the next operation. Moreover, in case that a plurality of operators performs operations simultaneously, since the operation speed is different from operator to operator, the overall speed needs to be set to an operator whose operation speed is the lowest. Thus, an overall efficiency of the operation which uses a belt conveyor may not be satisfactory.

In case that the technique disclosed in PTL 3 is used, and there are a number of different types of sorting objects, the apparatus for holding sorting objects may be complex and expensive. Moreover, when there are a large number of sorting destinations, the conveying device may have a large size and be complex. Further, in the configuration disclosed in PTL 4, a camera captures a parcel appearing on a reflection mirror. Thus, in order for the camera to capture the slip of the parcel in a focused state, the operator or the like may have to adjust the position and the inclination of the reflection mirror. However, the operation of adjusting the position and the inclination of the reflection mirror takes a considerable amount of time and is a little troublesome. Moreover, there is a possibility that the position and the inclination are not adjusted appropriately. If the position and the inclination of the reflection mirror are not adjusted appropriately, a problem that the camera cannot capture the slip of the parcel or a problem that the captured image of the slip of the parcel, obtained by the camera blurs may occur. If such a problem occurs, for example, it may become a hindrance to the sorting operation which uses the image captured by the camera and the sorting operation cannot be performed accurately. Further, in the technique disclosed in PTL 5, articles (for example, products) conveyed by the belt conveyor are projected to a monitor. Moreover, when a defective product is present in these articles, the image of the defective product (that is, an extraction target) is marked, for example, by an emphasized color in the image on the monitor. The operator picks the defective product out of the belt conveyor based on the image on the monitor. However, since the operator has to pick out the defective product while viewing and comparing the article on the belt conveyor and the monitor image, the operation efficiency is not satisfactory and there is a possibility that the operator picks out an article which is not a defective product.

The present invention has been devised to solve the above-described problems. That is, a main object of the present invention is to improve the efficiency and the accuracy of operators in the sorting operation performed manually without using complex and expensive apparatuses.

### Solution to Problem

To achieve the main object, an information processing device of the present invention includes:

an acquisition unit that acquires information on an operation executed on a processing object from a document associated with the processing object;

a detection unit that detects a position of the processing object; and

a notification control unit that detects an operation content for the processing object based on rules which are data correlated with the information on the operation and the operation content which uses the information, and notifying the operation content by controlling a notification device that notifies the operation content.

An information processing system of the present invention includes:

the information processing device of the present invention;

an information acquisition device that provides information representing the content of the document to the acquisition unit;

an information providing device that provides information on the position of the processing object to the detection unit; and

the notification device.

A distribution system of the present invention includes the information processing system of the present invention,

wherein the notification device notifies a sorting destination to which the processing object is sorted as information representing the operation content for the processing object.

An information processing method of the present invention, the information processing method for causing a computer to execute:

acquiring information on an operation executed on a processing object from a document associated with the processing object;

detecting an operation content for the processing object based on rules which are data correlated with the information on the operation and the operation content which uses the information; and

notifying the operation content.

A program storage medium of the present invention, the program storage medium storing a computer program for causing a computer to execute:

a process of acquiring information on an operation executed on a processing object from a document associated with the processing object;

a process of detecting a position of the processing object;

a process of detecting an operation content for the processing object based on rules which are data correlated with the information on the operation and the operation content which uses the information; and

a process of notifying the operation content.

The main object of the present invention can be also achieved by an information processing method corresponding to the information processing device of the present invention. Further, the main object of the present invention can be also achieved by a computer program that realizes the information processing device and the information processing method of the present invention or a program storage medium that stores the computer program.

### Advantageous Effects of Invention

The present invention enable to improve the efficiency and the accuracy of operators in the sorting operation performed manually without using complex and expensive apparatuses.

### BRIEF DESCRIPTION OF DRAWINGS

FIG. 1 is a block diagram illustrating a simplified configuration of an information processing system according to a first exemplary embodiment of the present invention.

FIG. 2 is a block diagram illustrating an example of hardware components that realize the information processing system according to the first exemplary embodiment.

FIG. 3 is a flowchart illustrating the flow of processing of the information processing system according to the first exemplary embodiment.

FIG. 4 is a diagram illustrating an example of a sorting object.

FIG. 5 is a diagram illustrating an example of a destination label attached to a sorting object in the first exemplary embodiment.

FIG. 6 is a diagram illustrating an example of sorting destination information stored in a database in the first exemplary embodiment.

FIG. 7 is a diagram representing a distribution system including the information processing system according to the first exemplary embodiment.

FIG. 8 is a diagram representing a distribution system including the information processing system according to the first exemplary embodiment.

FIG. 9 is a diagram representing a distribution system including an information processing system according to a second exemplary embodiment of the present invention.

FIG. 10 is a diagram representing a distribution system including an information processing system according to a third exemplary embodiment of the present invention.

FIG. 11 is a flowchart illustrating the flow of processing of the information processing system 1 according to the third exemplary embodiment.

FIG. 12 is a diagram representing a distribution system including an information processing system according to a fourth exemplary embodiment of the present invention.

FIG. 13 is a block diagram illustrating a simplified configuration of an information processing device according to a fifth exemplary embodiment of the present invention.

FIG. 14 is a diagram representing the information processing device according to the fifth embodiment.

FIG. 15 is a block diagram illustrating a simplified configuration of an information processing system according to a sixth exemplary embodiment of the present invention.

FIG. 16 is a diagram illustrating other exemplary embodiments of the present invention.

### DESCRIPTION OF EMBODIMENTS

First, in exemplary embodiments of the present invention, “means,” “device,” or “system” does not simply mean a physical means but the function of the “means,” “device,” or “system” may be realized by software. Moreover, the functions of one “means,” “device,” or “system” may not necessarily be realized by one physical means or device but may be realized by two or more physical means or devices. Further, the functions of two or more “means,” “devices,” or “system” may be realized by one physical means or device.

Hereinafter, exemplary embodiments of the present invention will be described with reference to the drawings.

### First Exemplary Embodiment

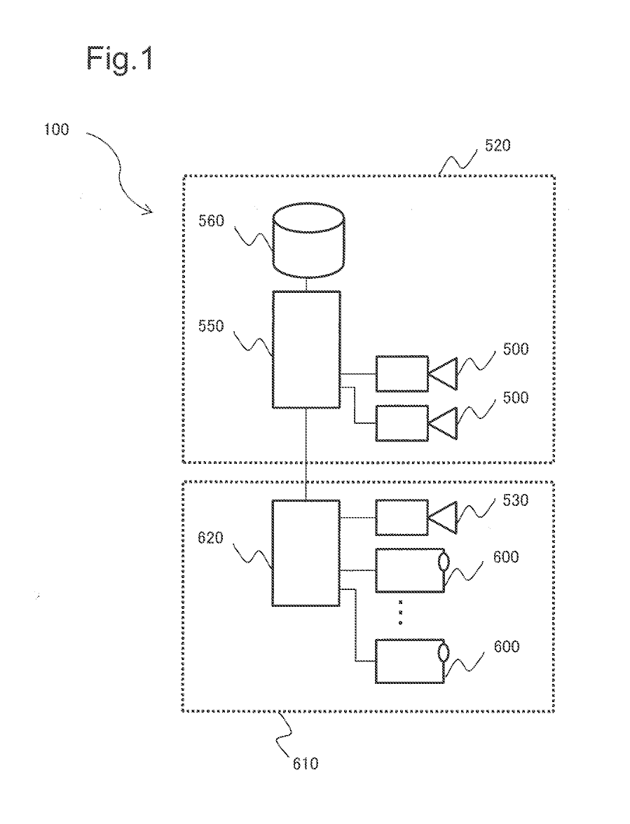

FIGS. 1 to 8 are diagrams representing a first exemplary embodiment of the present invention.

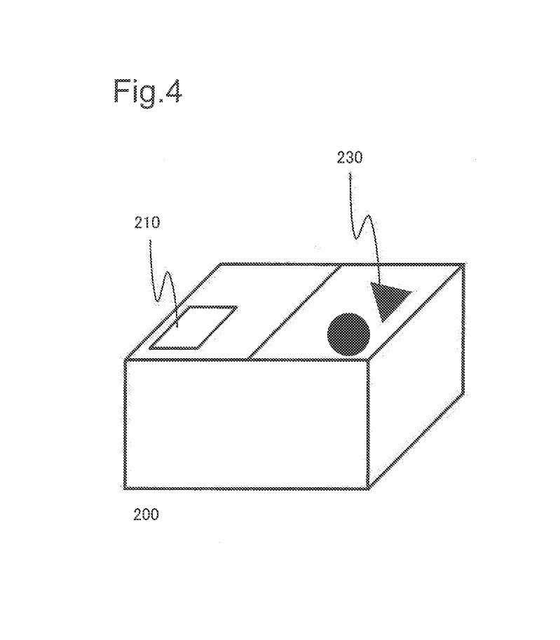

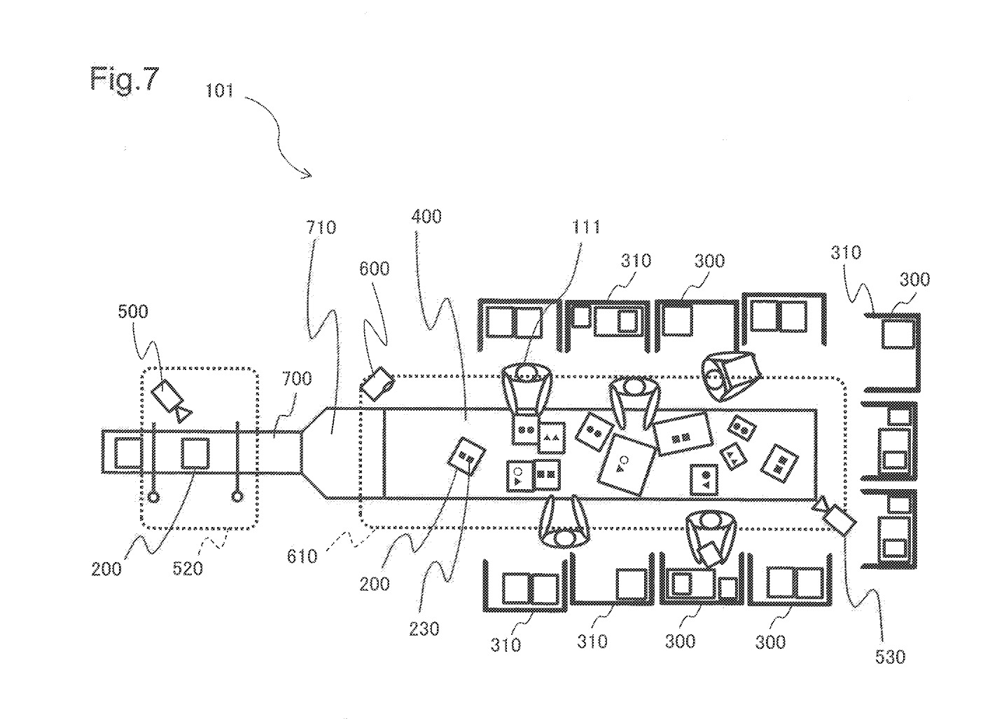

First, an outline of the first exemplary embodiment will be described with reference to FIGS. 4, 5 and 7. A sorting system which is a distribution system according to the first exemplary embodiment is applied to a distribution center or the like of a parcel service, for example. In this sorting system, as illustrated in FIG. 7, a sorting operator 111 examines a destination of a sorting object (processing object) 200 placed on a sorting table 400 and moves the sorting object 200 to a sorting destination 300 corresponding to the destination.

In such a sorting operation, generally, the sorting operator 111 recognizes the sorting destination 300 by examining a destination label 210 (see FIG. 4) attached to the sorting object 200. Subsequently, the sorting operator 111 carries the sorting object 200 to the sorting destination 300.

As described above, the sorting operator 111 reads information described in the destination label 210 of the sorting object 200 and recognizes the sorting destination 300 based on the information described in the destination label 210. However, generally, a number of items of information are described in the destination label 210, and the information used for sorting of the sorting object 200 is a portion of the items of information described in the destination label 210. Thus, a situation in which the sorting operator 111 wrongly reads the information used for the sorting from the destination label 210 and recognizes the wrong sorting destination 300 of the sorting object 200 may occur.

Thus, in the first exemplary embodiment, a recognition device 520 recognizes the destination label 210 and the shape of the sorting object 200 using an image captured by a camera 500. After that, the sorting object 200 is conveyed to the sorting table 400 by a conveying device 700. Moreover, a projection device 610 detects the sorting destination 300 of the sorting object 200 captured by the camera 530 and projects a sorting destination projection image 230 (see FIG. 4) representing the sorting destination 300 to an upper surface of the sorting object 200 with the aid of a projector 600. The sorting operator 111 examines the sorting destination projection image 230 and moves the sorting object 200 to the sorting destination 300 according to the sorting destination projection image 230. As a result, the sorting operator 111 can perform the sorting operation without recognizing and understanding the content of the destination label 210. Thus, the sorting operator 111 can accelerate the sorting operation and to decrease sorting errors.

The projector 600 starts projecting the sorting destination projection image 230 to the sorting object 200 when the sorting object 200 enters a projection area. Moreover, the projector 600 ends projecting the sorting destination projection image to the sorting object 200 when the sorting object 200 deviates from the projection area or when the sorting object 200 is not captured by the camera 530 even if the sorting object is in the projection area.

In the example of FIG. 7, although one camera 530 and one projector 600 are depicted, the number and the position of each of the cameras 530 and the projectors 600 may be changed appropriately according to the size of the capturing area of the camera 530 and the projection area of the projector 600.

Next, a configuration of an information processing system according to the first exemplary embodiment of the present invention will be described with reference to FIG. 1. The reference numerals in FIG. 1 are assigned to respective elements as examples to facilitate understanding of the present invention for the sake of convenience and are not intended to limit the present invention.

An information processing system 100 according to the first exemplary embodiment includes the recognition device 520 and the projection device 610. The recognition device 520 includes the camera 500, a control device 550, and a database 560. The recognition device 520 captures the whole shape of the sorting object 200 (see FIG. 4) conveyed sequentially and the destination label 210 attached to the sorting object 200 with the aid of the camera 500, and recognizes the destination and the shape of the sorting object.

That is, the camera 500 captures the whole shape and the destination label 210 of the sorting object 200. For example, a plurality of cameras 500 may be arranged so as to capture different positions of the same sorting object 200. This is because the attachment position of the destination label 210 in relation to the sorting object 200 is not fixed. Thus, by capturing the sorting object 200 from various directions, it is possible to capture the destination label 210 more reliably. Moreover, in case that a plurality of sorting objects 200 is present, the plurality of cameras 500 may be arranged so as to capture different places. In this way, these cameras 500 can capture a plurality of sorting objects 200 and the destination labels 210 attached to the sorting objects 200 simultaneously.

Moreover, for example, the same sorting object 200 may be captured at different places by one camera 500 while moving or rotating the sorting object 200. In this way, even when only one camera 500 is installed, it is possible to easily capture the destination label 210 and the whole shape of the sorting object 200. Moreover, the sorting object 200 may be disposed so that the destination label 210 faces a predetermined direction. Besides this, a dedicated label having an easily recognizable shape as the destination label 210 may be attached to an easily recognizable position of the sorting object 200. In this manner, various methods and device configurations for allowing the camera 500 to reliably capture the destination label 210 of the sorting object 200 may be considered. A specific method and device configuration may be selected depending on a situation in which the present invention is implemented.

Moreover, the operation of the camera 500 may be controlled by the control device 550, and for example, the camera 500 may include a control unit (not illustrated) and the control unit may control the operation of the camera 500. The camera 500 is connected to the control device 550 via a cable or wireless information communication network.

The control device 550 acquires the destination data described in the destination label 210 by processing the image (still image) or the video (moving images) of the destination label 210 captured by the camera 500. That is, the control device 550 functions as an acquisition unit that acquires information (the destination data) used for an operation (the sorting operation) executed with respect to a processing object (the sorting object 200) from a document (the destination label 210) attached to the processing object based on an image captured by the camera 500. Moreover, the camera 500 functions as an information acquisition device that provides the content of the document (the destination label 210) attached to the processing object to the acquisition unit (the control device 550).

Data correlated with the destination data and the data indicating the sorting destination 300 is stored in the database 560. That is, the rules which are the data correlated with the information (the destination data) used for the sorting operation and an operation content (the data indicating the sorting destination 300) which uses the information are stored in the database 560.

The control device 550 acquires data indicating the sorting destination 300 correlated with the acquired destination data from the database 560. That is, the control device 550 detects the operation content (the sorting destination 300) for the processing object (the sorting object 200). The control device 550 reads the destination data from the captured image (video) of the destination label 210 using an optical character recognition (OCR) function, for example. Moreover, relation data correlated with final destination information described in the destination label 210 and the delivery route information thereof and relation data correlated with the delivery route information and the data indicating the sorting destination 300 may be stored in the database 560. In this case, the control device 550 may read the delivery route information from the database 560 based on the final destination information described in the destination label 210 and determine the sorting destination 300 based on the read delivery route information. In this case, the sorting destination 300 is set to a sorting destination according to the parcel (item) stopover station in the middle of the delivery route, for example.

Moreover, in case that a plurality of items of other information (address, postal code, telephone number, and the like) related to the destination is described in the destination label 210, the control device 550 may determine the sorting destination 300 according to a predetermined priority order of the information.

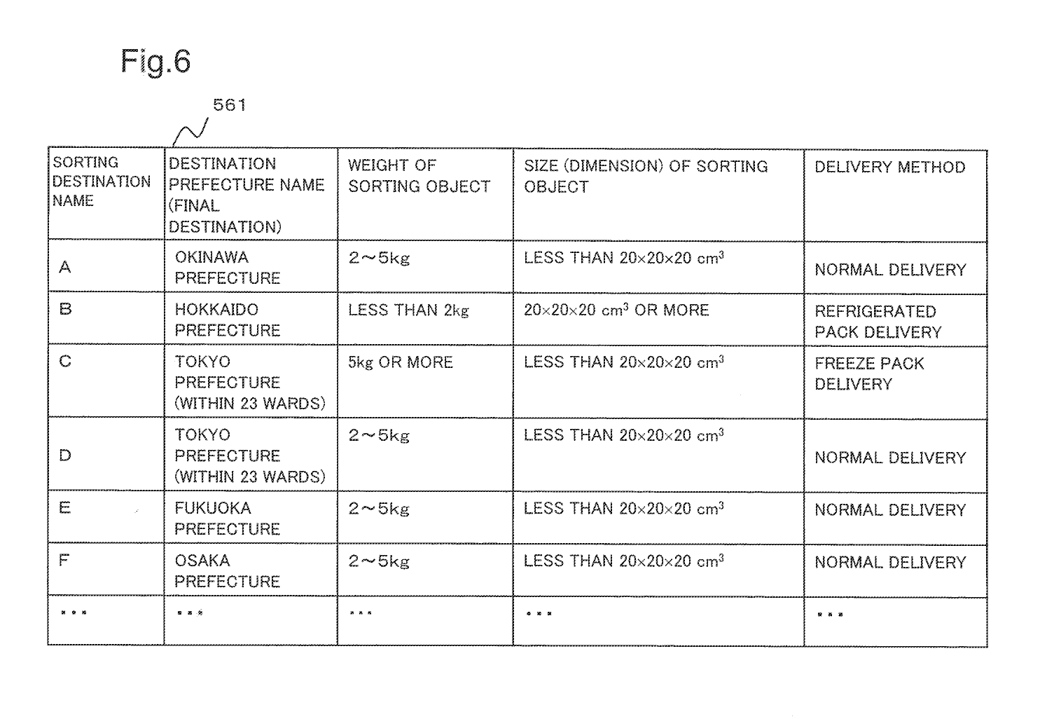

Further, the sorting object 200 may be sorted by taking the weight, the size, the delivery method and the like of the sorting object 200 into consideration, for example, rather than being sorted according to the destination only. In this case, for example, data (rule table 561) used for sorting as illustrated in FIG. 6 is stored in the database 560. Moreover, the control device 550 reads information such as the weight, the size and the delivery method as well as the information related to the destination from the destination label 210 of the sorting object 200.

The control device 550 registers the data correlated with the data of the recognized shape of the sorting object 200 and the data of the acquired sorting destination 300 in the database 560.

The distribution system 101 having the information processing system 100 of the first exemplary embodiment includes the conveying device 700 and the sorting table 400. The conveying device 700 is configured as a belt conveyor, for example, and conveys the sorting object 200. In the first exemplary embodiment, the camera 500 of the recognition device 520 is disposed at such a position as to capture the sorting object 200 conveyed by the conveying device 700. The control device 550 has a function of controlling the driving of the conveying device 700 so that the sorting object 200 can be captured appropriately by the camera 500. That is, the control device 550 also has a function of a conveyance control device. In the first exemplary embodiment, the sorting object 200 conveyed by the conveying device 700 is configured to be guided to the sorting table 400 through an introduction path 710.

Next, the configuration of the projection device 610 will be described. The projection device 610 includes the camera 530, the projector 600, and the control device 620. The projection device 610 may include a plurality of projectors 600, for example. Moreover, a plurality of cameras 530 may be provided instead of only one camera.

The camera 530 captures the sorting object 200 present on a working table (the sorting table 400 illustrated in FIG. 7). The control device 620 recognizes the shape and the location of the sorting object 200 using the image captured by the camera 530. That is, the control device 620 functions as a detection unit that detects the location of a processing object. Moreover, the camera 530 functions as an information providing device that provides the information on the location of the processing object (the sorting object 200) to the detection unit (the control device 620).

The control device 620 is communicably connected to the control device 550 of the recognition device 520 and receives, from the control device 550, the information related to the sorting object 200 recognized by the control device 550. The control device 620 compares the recognized shape of the sorting object 200 with the shape of the sorting object 200 recognized by the control device 550. Moreover, the control device 620 detects the sorting object 200 having a shape that matches the shape of the sorting object 200 captured by the camera 530 among the sorting objects 200 recognized by the control device 550. In this case, it is more preferable for the control device 620 to take information other than the shape into consideration in addition to the shape of the sorting object 200. For example, the control device 550 of the recognition device 520 acquires information other than the shape of the sorting object 200, such as the capturing time of the sorting object 200 captured by the camera 500 and the color of the sorting object 200 based on the captured image. Further, the control device 620 of the projection device 610 also acquires information other than the shape of the sorting object 200, such as the capturing time of the sorting object 200 captured by the camera 530 and the color of the sorting object 200 based on the captured image. Further, the control device 620 detects the sorting object 200 captured by the camera 530 based on the plurality of types of information acquired from the control device 550 and the various types of information acquired based on the captured image obtained by the camera 530. In this way, it is possible to improve the detection accuracy of the sorting object 200. Further, the control device 620 acquires the sorting destination information correlated with the detected sorting object 200. That is, the control device 620 detects the sorting destination 300 of the sorting object 200 captured by the camera 530.

In case that a plurality of the sorting objects 200 are present in the captured image obtained by the camera 530, the control device 620 detects the sorting destinations 300 of the respective sorting objects 200. Moreover, the control device 620 has a function capable of tracking the movement of the sorting object 200 based on the captured image obtained by the camera 530.

The projector 600 is a notification device that executes a projection operation according to a control operation of the control device 620. That is, the projector 600 projects the information (for example, the sorting destination projection image 230 (see FIG. 4)) on the sorting destination 300 to the sorting object 200 or to the vicinity thereof based on the information on the recognized location of the sorting object 200. The sorting destination projection image 230 is a character indicating the sorting destination 300 or an image of a figure, a symbol or the like related to the sorting destination 300, for example. Further, a character that describes the content of the sorting operation to the sorting operator 111 may be included in the sorting destination projection image 230.

That is, the control device 620 functions as a notification control unit that detects the operation content on the processing object based on the rules which are the data correlated with the information (the content of the destination label 210) used for the operation and the operation content and controls the projector 600 to send a notification of the operation content.

Although the control device 550, the database 560, and the control device 620 are illustrated as individual components in FIG. 1, these components may be integrated into one device and two of these components may be integrated into the same device. Moreover, these components may be configured as different devices according to the function, for example.

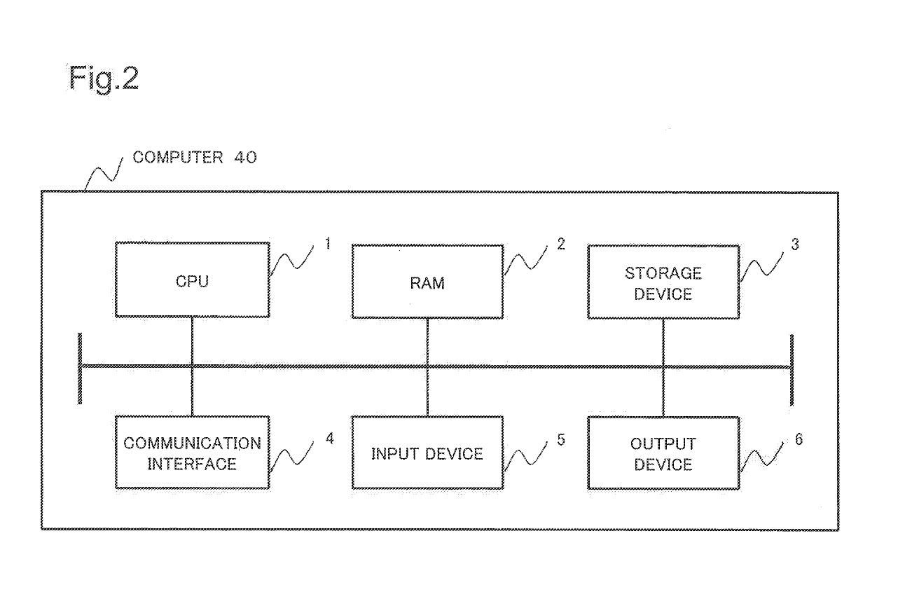

Next, the configuration of hardware components that realize the information processing system 100 of the first exemplary embodiment will be described with reference to FIG. 2.

FIG. 2 is a block diagram representing a configuration example of a computer 40 which is a hardware component that realizes the recognition device 520 and the projection device 610 that form the information processing system 100 according to the first exemplary embodiment. The computer 40 includes a central processing unit (CPU) 1, a random access memory (RAM) 2, a storage device 3, a communication interface 4, an input device 5 and an output device 6.

The functions of the control device 550 of the recognition device 520 and the control device 620 of the projection device 610 are realized by the CPU 1 that executes a computer program (program) read from the RAM 2. That is, the CPU 1 and the RAM 2 configure the control device 550 of the recognition device 520 and the control device 620 of the projection device 610 respectively. The storage device 3 is a device (storage medium) that includes a disk memory such as a hard disk, a flash memory and an optical disc, or a semiconductor memory, for example. The storage device 3 configures the database 560. The communication interface 4 is connected to the CPU 1 and has a function of connecting the CPU 1 to an information communication network or an external storage medium. External data may be imported into the CPU 1 via the communication interface 4.

The input device 5 is configured as the cameras 500 and 530. The output device 6 is configured as the projector 600. The above-described hardware components that configure the information processing system 100 are examples only, and the respective constituent elements illustrated in FIG. 2 may be configured as independent logical circuits. Moreover, the computer 40 may include a keyboard, a mouse, and a touch panel, for example, as the input device 5. Moreover, the computer 40 may include a display, for example, as the output device 6.

Hereinafter, the configuration of the information processing system 100 according to the first exemplary embodiment will be described in detail.

FIG. 4 is a diagram illustrating an example of the sorting object 200. Although the sorting object 200 illustrated in FIG. 4 has a rectangular parallelepiped shape, the sorting object 200 may have a shape other than the rectangular parallelepiped shape, such as a spherical shape.

As illustrated in FIG. 4, the destination label 210 is attached to the sorting object 200. Moreover, the sorting destination projection image 230 is projected to the surface (the upper surface (top surface) in the example of FIG. 4) of the sorting object 200 by the projector 600. The sorting destination projection image 230 is an image representing the information (for example, a character, a figure, a mark or the like representing the sorting destination 300) necessary for the sorting operation. By looking at the sorting destination projection image 230, the sorting operator 111 can understand the content of the sorting operation to be executed and sort the sorting object 200.

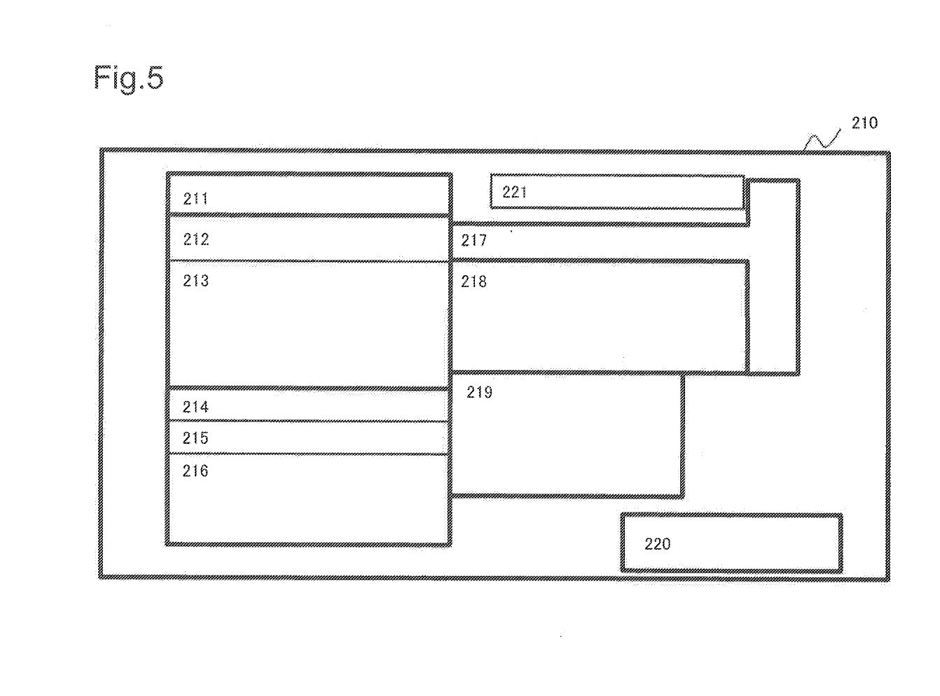

FIG. 5 is a diagram illustrating an example of the destination label 210 attached to the sorting object 200. The destination label 210 is a delivery slip, for example. In the destination label 210, a destination postal code area 211, a destination telephone number area 212, a destination address and name area 213, a client postal code area 214 and a client telephone number area 215 are set. Further, in the destination label 210, a client address and name area 216, a delivery date area 217, a delivery baggage content area 218, a delivery baggage dimension area 219, a slip number area 220, and a slip number barcode area 221 are set.

Besides these areas, a delivery type area that describes whether the corresponding parcel is for normal delivery or not, an area that describes an inquiry number for identifying a parcel, and the like may be set in the destination label 210. Moreover, the destination label 210 may have various formats, and the form of the destination label 210 is not limited to the form illustrated in FIG. 5.

The destination postal code area 211 is an area in which the postal code of the destination (shipping address) is described. For example, a number (for example, 000-1111) is described in the destination postal code area 211. The destination telephone number area 212 is an area in which the telephone number (a fixed telephone number, a mobile phone number or the like) of the destination is described. A number (for example, 090-0000-1111) is described in the destination telephone number area 212. The destination address and name area 213 is an area in which the address, the name and the like of the destination are described. For example, the prefectures, the municipalities, the building name and the name (for example, Taro Nippon, 1-1, Chiyoda-ku, Tokyo) are described in the destination address and name area 213.

The client postal code area 214 is an area in which the postal code of the client (sender) is described. For example, a number (for example, 000-2222) is described in the client postal code area 214. The client telephone number area 215 is an area in which the telephone number (a fixed telephone number, a mobile phone number, or the like) of the client is described. For example, a number (for example, 090-0000-2222) is described in the client telephone number area 215. The client address and name area 216 is an area in which the address, the name and the like of the client are described. For example, the prefectures, the municipalities, the building name and the name (for example, Taro Denki, 2-2, Chiyoda-ku, Tokyo) are described in the client address and name area 216.

The delivery date area 217 is an area in which the date of delivery is described. For example, the date and the hours (for example, 12 to 14 of January 1) on which a baggage is delivered are described in the delivery date area 217. The delivery baggage content area 218 is an area in which the content of a delivery baggage is described. For example, the name or the classification (for example, food and books) of the article included in the delivery baggage is described in the delivery baggage content area 218. The delivery baggage dimension area 219 is an area in which the information (dimension and cost) of the delivery baggage is described. For example, the size and the weight of a delivery baggage and a delivery charge (for example, a size: 120, a weight: 2 kg or lower and a delivery charge: 1500 yens) are described in the delivery baggage dimension area 219. The slip number area 220 is an area in which a slip number is described. The slip number barcode area 221 is an area in which a barcode indicating a slip number is described.

FIG. 6 is a diagram illustrating an example of the information (the sorting destination information) representing the sorting destination 300 stored in the database 560. The sorting destination information illustrated in FIG. 6 is the rule table 561, for example. The rule table 561 is a table (list) that correlates the content described in the destination label 210 and the name (sorting destination name) representing the sorting destination 300. The rule table 561 includes items such as a sorting destination name, a destination prefecture name (final destination), the weight of the sorting object, the size (dimension) of the sorting object, and a delivery method.

For example, the rule table 561 represents that the destination prefecture name (final destination) correlated with the sorting destination name “A” is “Okinawa prefecture,” and the weight of the sorting object is “2 to 5 kg”. Further, the rule table 561 represents that the size (dimension) of the sorting object correlated with the sorting destination name “A” is less than 20×20×20 cm³ and the delivery method is a “normal delivery”. The rule table 561 is not limited to the form illustrated in FIG. 6 but may be arbitrary information as long as the information is rule information used for the control device 550 to detect the sorting destination 300 based on the destination data acquired from the destination label 210, for example.

Moreover, the rule table 561 may be a table representing the regulation (rule) by which the sorting destination 300 (the operation content) is determined based on some items selected from a plurality of items of the rule table 561. Moreover, the rule table 561 may be a table representing the regulation (rule) by which the sorting destination 300 (the operation content) is determined based on all items of the rule table 561. Further, the rule table 561 may be a table representing the regulation (rule) by which the sorting destination 300 (the operation content) is determined by considering a predetermined priority order of a plurality of items of the rule table 561.

FIG. 7 is a model diagram representing the distribution system 101 including the information processing system 100 according to the first exemplary embodiment. In the distribution system 101, the recognition device 520 captures the sorting object 200 with the aid of the camera 500 and recognizes the destination and the shape of the sorting object 200 based on the captured image. When the processing of the recognition device 520 ends, the sorting object 200 is conveyed by the conveying device 700 and is moved to the sorting table 400 through the introduction path 710.

The projection device 610 detects the sorting destination 300 of the sorting object 200 on the sorting table 400 based on the captured image obtained by the camera 530 and projects the information representing the sorting destination 300 to the sorting object 200 with the aid of the projector 600. One or both of the camera 530 and the projector 600 may be provided to be movable. In this case, for example, the control device 620 performs control so that the camera 530 is moved to a position at which the sorting object 200 can be captured appropriately or performs control so that the projector 600 is moved to a position at which an image can be projected appropriately to the sorting object 200.

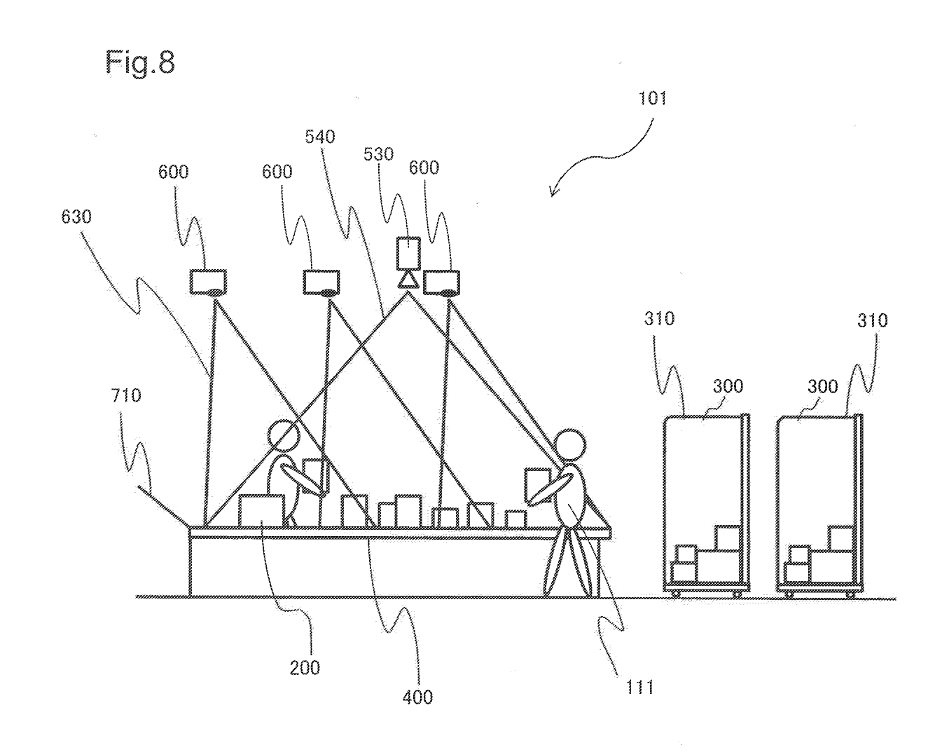

FIG. 8 is a diagram illustrating a state in which the sorting operator 111 executes the sorting operation when seen from the lateral side of the sorting operator 111. In the example of FIG. 8, the camera 530 has a capturing area 540 in which the entire upper surface of the sorting table 400 can be captured and can capture a plurality of sorting objects 200 simultaneously. Based on the captured image of the camera 530, the shape, the sorting destination 300 and the like of each sorting object 200 on the sorting table 400 are detected by the control device 620. In the example of FIG. 8, a plurality of projectors 600 is provided, and each projector 600 projects the information (the sorting destination projection image 230) representing the sorting destination 300 to the upper surface of the sorting object 200 in the projection area 630. Only one projector 600 may be provided rather than the plurality of projectors 600. In this case, the projector 600 has the projection area 630 in which an image can be projected to the entire upper surface area of the sorting table 400.

The sorting destination projection image 230 may be an image by which the sorting operator 111 can easily determine the sorting destination 300 and may be an image by which the sorting destination 300 can be determined based on a character such as a code number, a symbol, a figure, a shape, a color, or a combination thereof. Moreover, the sorting destination projection image 230 may change with time, for example.

Due to the fact that the surface color of the sorting object 200 is other than the white, the color of the image (the sorting destination projection image 230) projected to the sorting object 200 by the projector 600 may be different from an expected color. Thus, the sorting operator 111 may have difficulties in perceiving the sorting destination projection image 230. In such a case, for example, the control device 620 may detect the surface color of the sorting object 200 based on the image captured by the camera 530 and change the color of the sorting destination projection image 230 so that the sorting destination projection image 230 projected to the sorting object 200 is clearly visible. Moreover, the sorting destination projection image 230 may indicate the sorting destination 300 using a combination of a color, a code number and the like.

Moreover, the control device 620 may rotate or move the sorting destination projection image 230 to be projected to the sorting object 200 according to the position and the direction of any one of the sorting object 200, the sorting operator 111 and the sorting destination 300. Moreover, for example, the control device 620 is given data that determines the direction of the sorting destination projection image 230 to be projected based on a relative position of the sorting object 200 in relation to the sorting destination 300. In such a case, the control device 620 may rotate or move a portion or an entire portion of the sorting destination projection image 230 to be projected based on the data according to the relative position of the sorting object 200 in relation to the sorting destination 300. In such a case, the projection device 610 (the control device 620) can continue projecting the sorting destination projection image 230 to the sorting object 200 while tracking the moving sorting object 200. The control device 620 may project an image indicating the direction to the sorting destination 300 using a symbol or a text based on the direction determined by the relative position with the aid of the projector 600.

Moreover, the control device 620 may change the content of the sorting destination projection image 230 to be projected according to the situation of the sorting operator 111. That is, the sorting operator 111 may be present at a place distant from the sorting destination 300. Moreover, a workload may be different depending on the sorting operator 111, and there is a case in which it is preferable to adjust the workload so that the workloads of respective sorting operators 111 are equalized. With such a case taken into consideration, the projection device 610 may include a function of detecting the location of the sorting operator 111. For example, the configuration of detecting the location of the sorting operator 111 has a camera that captures the sorting operator 111 and a computer that detects the position of the sorting operator 111 based on the captured image obtained by the camera. Moreover, the control device 620 may have a function of determining a person in charge responsible for sorting the sorting object 200 using the workload or the like of the sorting operator 111 based on the location of the sorting operator 111, the information on the sorting object 200 obtained from the control device 550 and the like. Further, the control device 620 may have a function of controlling the projector 600 so that the name or the like of the sorting operator 111 determined as the person in charge responsible for sorting the sorting object 200 is projected to the sorting object 200 as the sorting destination projection image 230. Furthermore, the control device 620 may have a function of detecting the sorting operator 111 as the person in charge approaching the sorting object 200 or the sorting operator 111 as the person in charge stretching out his or her hands toward the sorting object 200. Moreover, the control device 620 may have a function of changing the content of the sorting destination projection image 230 being projected to the sorting object 200, for example, from the information representing the name or the like of the sorting operator 111 as the person in charge to the information representing the sorting destination 300 when such a situation is detected.

Further, the control device 620 may include a time measurement unit (not illustrated) that measures the time elapsed after the sorting object 200 is detected based on the captured image obtained by the camera 530. Moreover, the control device 620 may have a function of changing the content of the sorting destination projection image 230 to be projected by the projector 600 based on a predetermined rule according to the time (the time elapsed after the sorting object 200 is detected) measured by the time measurement unit. Further, the control device 620 may include a timer (not illustrated) that detects the elapse of a predetermined period Ts after the sorting object 200 is detected based on the captured image obtained by the camera 530. In this case, for example, the control device 620 drives the timer when the sorting object 200 is detected based on the captured image obtained by the camera 530. Moreover, the control device 620 may change the content of the sorting destination projection image 230 to be projected by the projector 600 when the timer detects the elapse of the predetermined period Ts. As a specific example, the sorting destination projection image 230 is changed from the image representing the sorting destination 300 to an image such as a character or a mark for pushing the sorting operator to perform the sorting operation of the sorting object 200. If the sorting object 200 is continuously detected even when the predetermined period Ts is elapsed after the sorting object 200 is detected, there is a possibility that the operator has forgotten sorting the sorting object 200. The configuration, which presses the operator to perform the sorting operation as described above by taking such the situation into consideration, enables to cause the operator to preferentially execute the sorting operation of the sorting object 200 being forgotten to be sorted.

Furthermore, the control device 620 may project a business contact to the sorting operator 111 as well as the sorting destination projection image 230 to the sorting object 200 or the vicinity thereof by controlling the projector 600.

Moreover, the control device 620 may project the information related to the sorting object 200 together with the sorting destination projection image 230 to the sorting object 200 or the vicinity thereof by controlling the projector 600. For example, the information related to the sorting object 200 includes the weight of the sorting object 200, precautions on handling such as “This side up” or “Do not stack,” and the period in which the sorting object is left on the sorting table 400. Further, the information related to the sorting object 200 includes additional information such as a shipping time according to the sorting destination 300 and the order when the sorting object is stacked on the roll box pallet 310 which is the sorting destination 300. Further, the information related to the sorting object 200 includes additional information such as the location of the sorting objects 200 of the same class to be sorted to the same sorting destination 300 and warning statements on the sorting object 200 left unprocessed for a long period.

As described above, depending on the addition information projected to the sorting object 200 or the vicinity thereof, a weight measurement device may be provided in the sorting table 400.

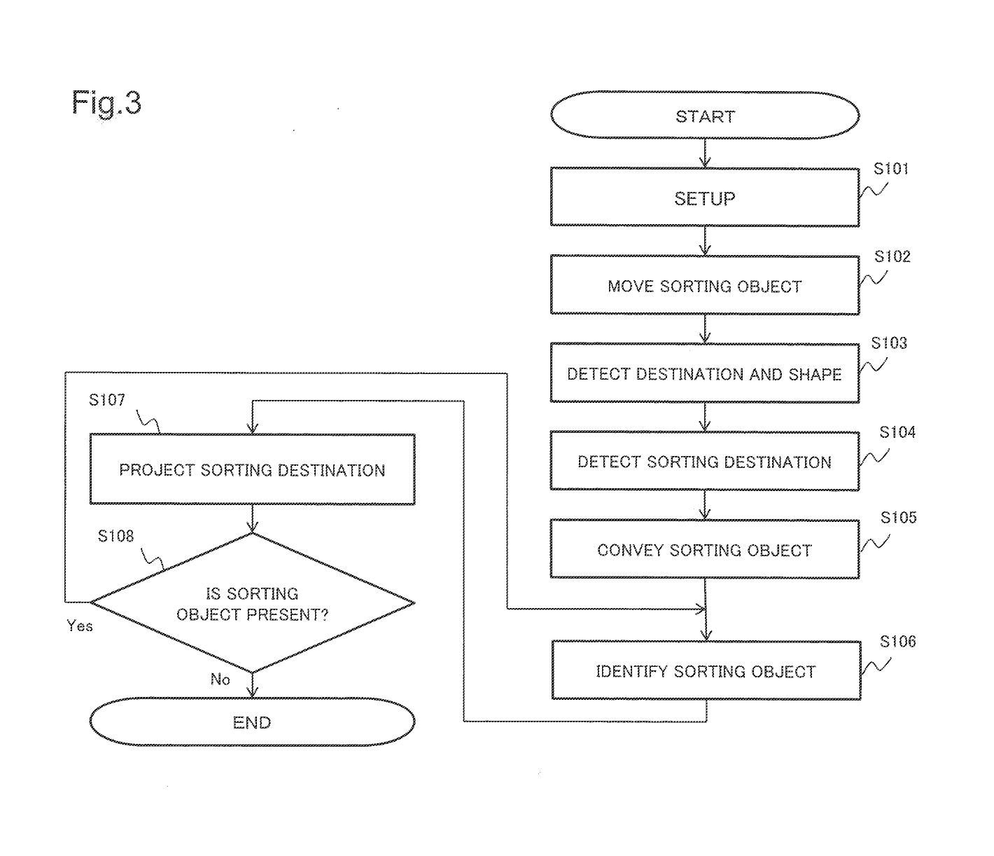

Next, the operation (the flow of processing) of the information processing system 100 according to the first exemplary embodiment will be described based on FIG. 3. FIG. 3 is a flowchart illustrating the flow of processing of the information processing system 100 (the control device 550 and the control device 620). The flow of processing illustrated in FIG. 3 is an example, and the processing order may be changed appropriately and processing may be repeated.

Moreover, processing may be executed in parallel within such a range that will not cause inconsistency in the processing content. Further, other process may be added between respective processes.

First, the control device 550 registers (sets up) the information on the sorting destination 300 in the database 560 (step S101). The information of the sorting destination 300 may be registered in advance in the database 560.

Subsequently, the control device 550 moves the sorting object 200 to the capturing area of the camera 500 of the recognition device 520 by controlling the conveying device (for example, a belt conveyor) 700 (step S102).

Subsequently, the control device 550 captures the sorting object 200 by controlling the camera 500. Moreover, the control device 550 acquires the content of the destination label 210 attached to the sorting object 200 based on the image of the sorting object 200 captured by the camera 500. Moreover, the control device 550 detects the shape of the sorting object 200 based on the captured image obtained by the camera 500 (step S103). When the information (for example, 20 cm×30 cm×30 cm) on the size of the sorting object 200 is described in the destination label 210, the control device 550 may read the information from the captured image obtained by the camera 500. Moreover, the camera 500 rather than the control device 550 may have a function of the acquiring information from the captured image. In this case, the camera 500 may acquire the content of the destination label 210 of the sorting object 200 and detect the shape of the sorting object 200. Moreover, the camera 500 may transmit the information detected in this manner to the control device 550 by cable or wireless communication.

The control device 550 compares the information of the sorting object 200 obtained based on the captured image obtained by the camera 500 with the rule table 561 of the database 560, for example, and detects the sorting destination 300 of the sorting object 200 (step S104). Moreover, the control device 550 stores the sorting destination information in a temporarily storage area (not illustrated), for example, by correlating a unique identification number (ID), an acquisition time, and shape information of the sorting object 200 with the data (sorting destination information) of the detected sorting destination 300. Moreover, the sorting destination information is transmitted from the control device 550 to the control device 620 of the projection device 610.

After that, the control device 550 conveys the sorting object 200 to the sorting table 400 by controlling the conveying device 700 (step S105).

Moreover, based on the control of the control device 620 of the projection device 610, the camera 530 captures the sorting object 200 conveyed to the sorting table 400. The control device 620 detects the shape of the sorting object 200 based on the captured image obtained by the camera 530. Further, the control device 620 acquires the ID correlated with the sorting object 200 on the sorting table 400 from the sorting destination information transmitted from the control device 550 based on the detected shape of the sorting object 200. Moreover, the control device 550 detects the sorting destination 300 of the sorting object 200 on the sorting table 400 based on the sorting destination information and the detected shape of the sorting object 200. Further, the control device 550 acquires the location information of the sorting object 200 on the sorting table 400 (step S106).

The control device 620 projects the sorting destination projection image 230 representing the sorting destination 300 to the sorting object 200 on the sorting table 400 or the vicinity thereof by controlling the projector 600 (step S107).

After that, the control device 620 determines whether the sorting object 200 is present in the capturing area 540 of the camera 530 based on the captured image obtained by the camera 530 (step S108). When the sorting object 200 is present, the operation subsequent to step S106 is repeated. In this way, the projection device 610 continues projecting the sorting destination projection image 230 to the sorting object 200 or the vicinity thereof.

Moreover, when it is determined in step S108 that the sorting object is not present, the control device 620 stops projecting the sorting destination projection image 230 and ends processing. That is, the sorting destination projection image 230 is continuously projected in a period in which the sorting object 200 is not processed by the sorting operator 111 and the sorting object 200 is present on the sorting table 400. Moreover, when the sorting object 200 is moved from the sorting table 400 by the sorting operator 111, projection of the sorting destination projection image 230 ends. There may be a case in which the sorting object 200 enters into the shadow of the sorting operator 111 or another sorting object 200 and is not captured by the camera 530. In this case, projection of the sorting destination projection image 230 ends.

The information processing system 100 of the first exemplary embodiment executes the above-described processing.

When the information processing system 100 of the first exemplary embodiment is employed, the sorting operator 111 moves the sorting object 200 to the sorting destination 300 based on the sorting destination projection image 230 projected to the sorting object 200. The information processing system 100 of the first exemplary embodiment executes a series of processes involving recognition of the sorting object 200 and projection of the sorting destination projection image 230 to the sorting object 200 with the aid of the control devices 550 and 620. Thus, the sorting operator 111 does not need to perform an operation of operating the cameras 500 and 530 to capture the sorting object 200 and an operation of operating the control device 620 so that image processing related to recognition of the sorting object 200 is executed.

In the above description, although processing of one sorting object 200 has been described, the information processing system 100 can process a plurality of sorting objects 200 in parallel.

That is, when a plurality of sorting objects 200 is included in the captured image obtained by each of the cameras 500 and 530, the control device 550 of the recognition device 520 and the control device 620 of the projection device 610 can perform the shape recognition process and the like individually for the respective sorting objects 200. In the example of FIG. 1, although one projection device 610 is connected to one recognition device 520, a plurality of projection devices 610 may be connected to one recognition device 520.

The information processing system 100 of the first exemplary embodiment is configured in the above-described manner. In this way, the information processing system 100 can provide the following advantages.

That is, in the information processing system 100 of the first exemplary embodiment, the control device 550 recognizes the shape of the sorting object 200 and acquires the destination data from the destination label 210 based on the image captured by the camera 500 of the recognition device 520. Further, the control device 550 acquires the information of the sorting destination 300 of the sorting object 200 from the database 560 based on the destination data. The control device 620 of the projection device 610 recognizes the shape and the location of the sorting object 200 on the sorting table 400 based on the captured image obtained by the camera 530. Moreover, the control device 620 receives from the control device 550 the data correlated with the shape information of the sorting object 200 recognized by the control device 550 of the recognition device 520 and the information of the sorting destination 300 of the sorting object 200. Further, the control device 620 detects the sorting destination 300 of the recognized sorting object 200 based on the recognized shape information of the sorting object 200 and the data received from the control device 550. Furthermore, the control device 620 projects the sorting destination projection image 230 representing the sorting destination 300 to the sorting object 200 or the vicinity thereof by controlling the projector 600. By using the information projected to the sorting object 200, the sorting operator 111 can recognize the sorting destination 300 of the sorting object 200 easily and accurately. In this way, the information processing system 100 can improve the efficiency of the sorting operation and to decrease sorting errors.

Moreover, the information processing system 100 enables the sorting operation to be performed even when the sorting operator 111 does not have prior knowledge necessary for reading (understanding) the destination label 210 of the sorting object 200. In this way, the information processing system 100 can reduce errors of the sorting operator 111 reading or judging the sorting destination 300. Thus, the information processing system 100 enables to improve the efficiency of the sorting operation.

In the above example, the projector 600 projects the sorting destination projection image 230 to the sorting object 200 using visible light. Instead of this, the projector 600 may emit invisible light (for example, infrared light) to the sorting object 200 so that the sorting destination projection image 230 floats on the sorting object 200. That is, a special paint that exhibits colors (light) in response to invisible light may be applied in advance to the sorting object 200. Alternatively, a seal or the like to which such a special paint is applied may be attached in advance to an upper surface of the sorting object 200, for example, outside the destination label 210. Moreover, when the projector 600 projects the sorting destination projection image 230 to the sorting object 200 using invisible light, the paint reacts to the invisible light so that the sorting destination projection image 230 floats. In this way, the sorting operator 111 can see (recognize) the sorting destination projection image 230 with naked eyes.

When the projector 600 emits visible light, the visible light may dazzle the sorting operator 111 to become a hindrance to the visual operation of the sorting operator 111. However, when the projector 600 emits invisible light, such a problem can be prevented. In this way, a configuration in which the projector 600 emits invisible light can suppress the sorting errors resulting from visible light.

Further, when the size of the destination label 210 attached to the sorting object 200 is small as compared to the sorting object 200 so that the sorting operator 111 has to look at both the sorting object 200 and the destination label 210, the burden of the sorting operator 111 increases. That is, in such a case, the sorting operator 111 has to change his or her viewing range when looking at the sorting object 200 and when looking at the destination label 210. Thus, the burden on the eyes of the sorting operator 111 increases. In contrast, when the information processing system 100 is introduced, since the sorting operator 111 does not need to look at the destination label 210, it is possible to relieve the burden on the eyes of the sorting operator 111. This contributes to reduction in errors in the sorting operation and improvement in the efficiency of the sorting operation.

Moreover, when a plurality of sorting operators 111 sorts the sorting objects 200 moved by a belt conveyor, for example, the moving speed of the sorting object 200 by the belt conveyor is set according to the processing speed of the sorting operator 111 who is behind with operations. In such a case, the sorting operator 111 who is ahead in operations may often wait for the next sorting object 200, which is a waste of time. In contrast, in the information processing system 100 of the first exemplary embodiment, the sorting object 200 sorted by the sorting operator 111 is placed on the sorting table 400 rather than a belt conveyor. Thus, the sorting operators 111 can perform the sorting operation based on the respective processing speeds. In this way, the sorting operation based on the information processing system 100 of the first exemplary embodiment enables to be performed with higher efficiency than a method which uses a belt conveyor.

### Second Exemplary Embodiment

Hereinafter, an information processing system according to a second exemplary embodiment of the present invention and a distribution system including the information processing system will be described. In the description of the second exemplary embodiment, the same constituent elements as those of the information processing system and the distribution system of the first exemplary embodiment will be denoted by the same reference numerals, and the redundant description thereof will not be provided.

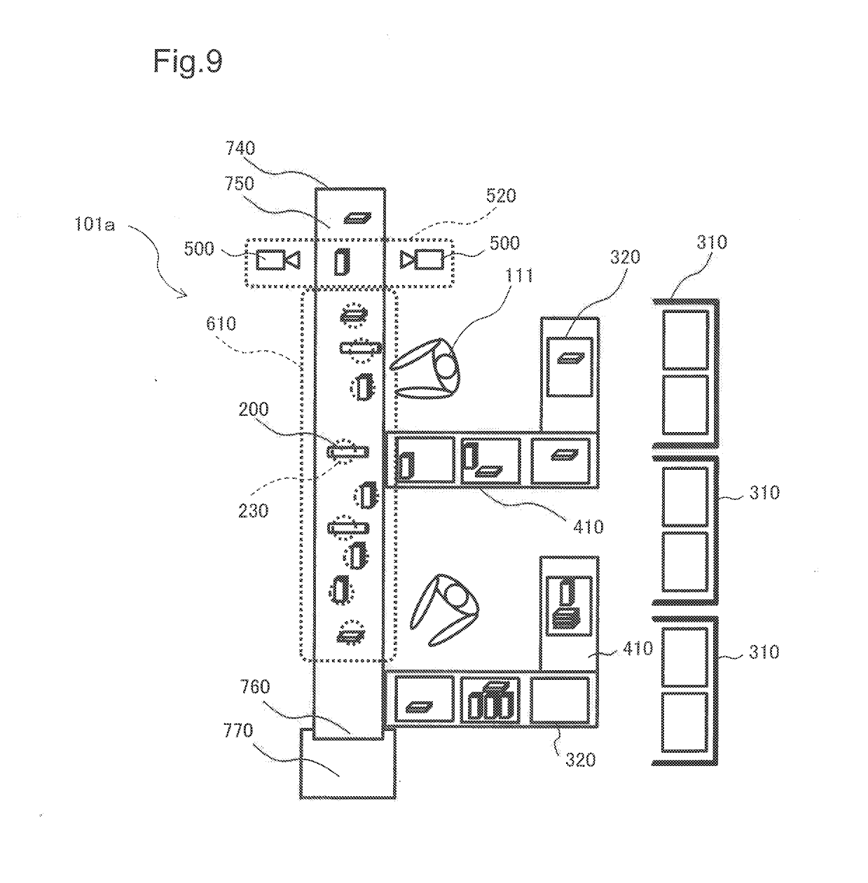

FIG. 9 is a diagram representing the information processing system and the distribution system according to the second exemplary embodiment.

In the second exemplary embodiment, the information processing system 100 has the same configuration as the information processing system 100 of the first exemplary embodiment. Moreover, the distribution system 101a uses a belt conveyor 750 instead of the sorting table 400 that configures the distribution system 101 of the first exemplary embodiment. Moreover, the distribution system 101a includes a container 320, a desk 410, and a collection box 770.

In the second exemplary embodiment, a case in which small sorting objects 200 such as an envelope or a small article are sorted is considered. When the sorting object 200 is a small article, troubles such as destruction or missing are more likely to occur as compared to large articles. The distribution system 101a of the second exemplary embodiment is constructed by taking this into consideration. That is, in the distribution system 101a, first, the sorting operator 111 performs the sorting operation of sorting the sorting object 200 to the container 320 and then moving the container 320 to the sorting destination 300 (the roll box pallet 310 in the example of FIG. 9) corresponding to the container 320. The distribution system 101a of the second embodiment has a configuration that improves the efficiency of such a sorting operation.

That is, the information processing system 100 that configures the distribution system 101a of the second exemplary embodiment recognizes the shape and the sorting destination 300 of the sorting object 200 with the aid of the recognition device 520 similarly to the first exemplary embodiment. Moreover, the information processing system 100 projects the sorting destination projection image 230 representing the recognized sorting destination of the sorting object 200 to the sorting object 200 or the vicinity thereof with the aid of the projector 600 illustrated in FIG. 8, for example, of the projection device 610. The form of the sorting destination projection image 230 is not particularly limited, but various forms may be used as long as the sorting destination projection image 230 can be recognized with the naked eyes of the sorting operator 111, for example. For example, the sorting destination projection image 230 has the form of a line that connects the character or the symbol representing the destination and the sorting object 200 and may have the form of a frame that surrounds the character or the symbol representing the destination. In the second exemplary embodiment, the sorting destination projection image 230 projected to the sorting object 200 represents the container 320 of the sorting destination rather than the roll box pallet 310.

In the distribution system 101a of the second exemplary embodiment, the sorting operator 111 recognizes the sorting destination projection image 230 projected to the sorting object 200 or the vicinity thereof by the projector 600 of the information processing system 100. Moreover, the sorting operator 111 stores the sorting object 200 in a predetermined container 320. The sorting object 200 may be sorted to a determined area of the desk 410 instead of the container 320 and is sorted according to a predetermined sorting destination. After that, the sorting operator 111 moves the plurality of sorting objects 200 sorted according to the sorting destination to the roll box pallet 310 of the sorting destination 300.

In this example, the sorting object 200 is first sorted (classified) by the container 320. Further, as a tool for sorting the sorting object 200, for example, a folding container, a dedicated case, a tray, a cardboard box, a packaging wrap, an envelope, a wrapping paper, a rope, a belt, and the like may be used instead of the container 320. That is, an appropriate tool that takes the shape, the weight, and the like of the sorting object 200 into consideration is used as a sorting tool.

In the second exemplary embodiment, the belt conveyor 750 is configured to convey the sorting object 200 through an area in which the shape and the sorting destination of the sorting object 200 are recognized by the recognition device 520 and an area in which the sorting destination is projected to the sorting object 200 by the projection device 610. Since the distribution system 101a includes such a belt conveyor 750, a state in which the sorting object 200 is moved continuously is created. Due to this, a case in which the sorting object 200 passes over the area of the sorting operator 111 who has to handle the sorting object 200 may occur. In such a case, the sorting operator 111 working on the downstream side of the belt conveyor 750 may sort the sorting object 200 which has not been sorted. Moreover, the sorting object 200 which has not been sorted by any one of the sorting operators 111 is collected into the collection box 770 from a terminating end 760 of the belt conveyor 750. Moreover, the collected sorting object 200 is sorted by being loaded on the belt conveyor 750 again from a starting end 740.

The projection device 610 may include a plurality of projectors 600, and these projectors 600 may be disposed at intervals in a direction in which the sorting object 200 is moved by the belt conveyor 750. In this case, with movement of the sorting object 200, the projector 600 that projects the sorting destination projection image 230 to the sorting object 200 is switched.

Moreover, the driving speed of the belt conveyor 750 is appropriately set by taking the speed of the sorting operation of the sorting operator 111 into consideration. Further, the driving speed of the belt conveyor 750 may be adjusted by a controller (not illustrated) disposed around the sorting operator 111 or a controller (not illustrated) which is a wearable terminal worn on the sorting operator 111, for example. Furthermore, a device that detects the number of sorting objects 200 being moved by the belt conveyor 750 may be provided. This device is configured to be able to detect the number of sorting objects 200 near the terminating end 760 of the belt conveyor 750, for example. Moreover, this device is a device which includes a camera and an arithmetic device that detects the number of sorting objects 200 by processing a captured image obtained by the camera, for example. A configuration that adjusts the driving speed of the belt conveyor 750 according to the number of sorting objects 200 detected by such a device and stops the belt conveyor 750 may be included in the distribution system 101a.

Since the configurations other than the above-described configuration, of the information processing system 100 and the distribution system 101a according to the second exemplary embodiment are the same as those of the first exemplary embodiment, the description thereof will not be provided.

Since the distribution system 101a according to the second exemplary embodiment includes the information processing system 100 having the same configuration as the information processing system 100 of the first exemplary embodiment, the distribution system 101a enables to obtain the advantages obtained from the information processing system 100. That is, the distribution system 101a of the second exemplary embodiment enables to improve the efficiency of the sorting operation and to suppress the errors of the sorting operation.

### Third Exemplary Embodiment

Hereinafter, a third exemplary embodiment of the present invention will be described. In the description of the third exemplary embodiment, the same constituent elements as those of the information processing system and the distribution system of the first or second exemplary embodiment will be denoted by the same reference numerals, and the redundant description thereof will not be provided.

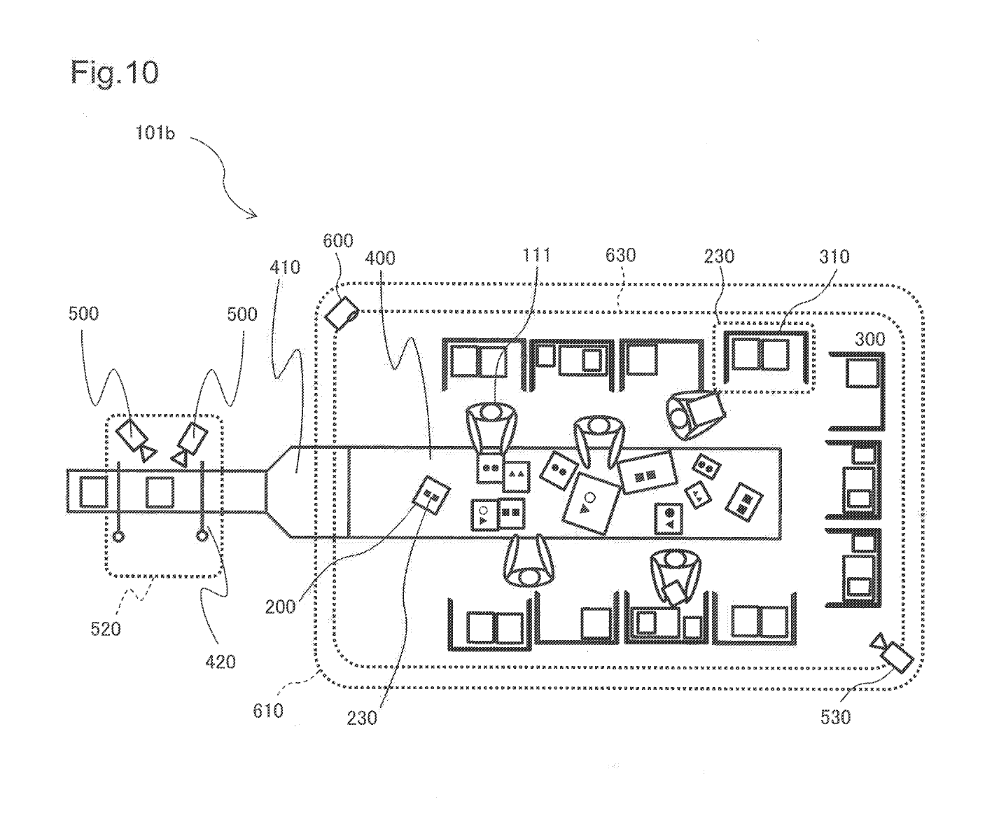

FIG. 10 is a diagram representing the information processing system according to the third exemplary embodiment and the distribution system including that information processing system.

The recognition device 520 that configures the information processing system 100 of the third exemplary embodiment includes the same configuration as that of the first exemplary embodiment. Moreover, the number of installed projectors 600 of the projection device 610 and the number of installed locations thereof are set so that at least a portion of the sorting destination 300 is included in the projection area 630. Moreover, the number of installed cameras 530 and the number of installed locations thereof are set so that an area including the projection area 630 of the projector 600 can be captured.

In the third exemplary embodiment, the control device 620 of the projection device 610 recognizes the sorting destination 300 of the sorting object 200 based on the captured image obtained by the camera 530 similarly to the first exemplary embodiment. Moreover, the control device 620 projects the sorting destination projection image 230 representing the sorting destination 300 to the sorting object 200 or the vicinity thereof by controlling the projector 600. Further, in the third exemplary embodiment, the control device 620 may have a function of projecting the sorting destination projection image 230 to the sorting destination 300 of the sorting object 200 to which the sorting destination projection image 230 is projected by controlling the projector 600. In this way, the sorting operator 111 can clearly understand the sorting destination 300 of the sorting object 200 and improve the working efficiency.

The configurations other than the above-described configuration, of the information processing system 100 and the distribution system 101b of the third exemplary embodiment are the same as those of the first exemplary embodiment, and the description thereof will not be provided.

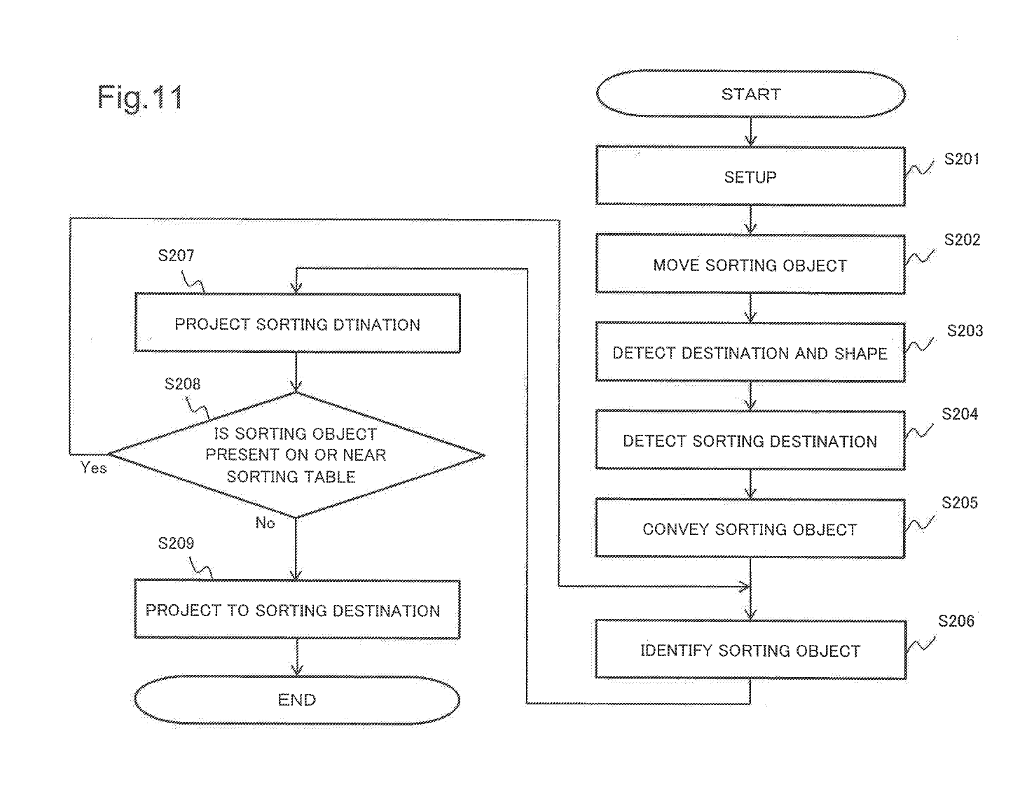

Hereinafter, the flow of processing of the information processing system 100 according to the third exemplary embodiment will be described with reference to FIG. 11. FIG. 11 is a flowchart illustrating the flow of processing of the information processing system 100.

First, the control device 550 of the recognition device 520 registers the sorting destinations of sorting destinations 300 in the database 560 and registers (sets up) the positions of the individual roll box pallets 310 of the sorting destinations 300 (step S201).

After that, the information processing system 100 performs the same processes as steps S102 to S107 of the processing of the first exemplary embodiment (steps S202 to S207).

After projection of the sorting destination projection image 230 to the sorting object 200 starts, the control device 620 of the projection device 610 determines whether the sorting object 200 is present on the sorting table 400 or in the vicinity thereof based on the captured image obtained by the camera 530 (step S208). Moreover, when the sorting object 200 is present on the sorting table 400 or in the vicinity thereof, the control device 620 continues projecting the sorting destination projection image 230 to the sorting object 200 by repeating the operations subsequent to step S206.

Moreover, for example, when the sorting operator 111 separates the sorting object 200 from the sorting table 400 to move the sorting object 200 to the sorting destination 300, the sorting object 200 is not present on the sorting table 400 or in the vicinity thereof. In such a case, the projection device 610 stops projecting the sorting destination projection image 230. Moreover, the projection device 610 projects an image (for example, the sorting destination projection image 230) representing the sorting destination 300 of the sorting object 200 to the sorting destination 300 (for example, the roll box pallet 310) for a predetermined period (step S209). The projection period is set to a period obtained by adding a margin period to an expected period required for the sorting operator 111 to move the sorting object 200 from the sorting table 400 to the sorting destination 300, for example. In this way, since the sorting destination projection image 230 is also projected to the sorting destination 300, for example, the possibility that the sorting operator 111 moves the sorting object 200 from the sorting table 400 to a wrong sorting destination is reduced.

The sorting destination projection image 230 projected to the sorting destination 300 may be the same as or different from the sorting destination projection image 230 projected to the sorting object 200. The sorting destination projection image 230 may be one of a name, a code number, a symbol, a figure, a form, a color and the like, for example, which can be easily distinguished, or may be a mixture thereof. Moreover, the sorting destination projection image 230 may be such an image of which the brightness, the tone, and the projection position change with time and may be combined with a moving image.

The information processing system 100 and the distribution system 101b of the third exemplary embodiment includes the information processing system 100 having the same configuration as the information processing system 100 of the first exemplary embodiment. Thus, the information processing system 100 and the distribution system 101b enables to improve the efficiency of the sorting operation and decrease the sorting errors similarly to the first exemplary embodiment.

Further, in the third exemplary embodiment, the control device 620 has a function of projecting the sorting destination projection image 230 to the sorting destination 300 as well as the sorting object 200. Thus, since the sorting operator 111 can recognize the sorting destination 300 more directly, it is possible to further decrease the sorting errors.

Moreover, in the third exemplary embodiment, when the sorting operator 111 recognizes the characters and the symbols of a plurality of roll box pallets 310, it is clear that the roll box pallet 310 at which the light emitted from the projector 600 arrives is the target roll box pallet 310. Thus, the sorting operator 111 does not need to pay attention to the individual roll box pallets 310. As a result, incidentally, the fatigue of the sorting operator 111 decreases and the efficiency of the sorting operation is improved.

### Fourth Exemplary Embodiment

Hereinafter, a fourth exemplary embodiment of the present invention will be described. In the description of the fourth exemplary embodiment, the same constituent elements as those of the information processing system and the distribution system of the first, the second, or the third exemplary embodiment will be denoted by the same reference numerals, and the redundant description thereof will not be provided.

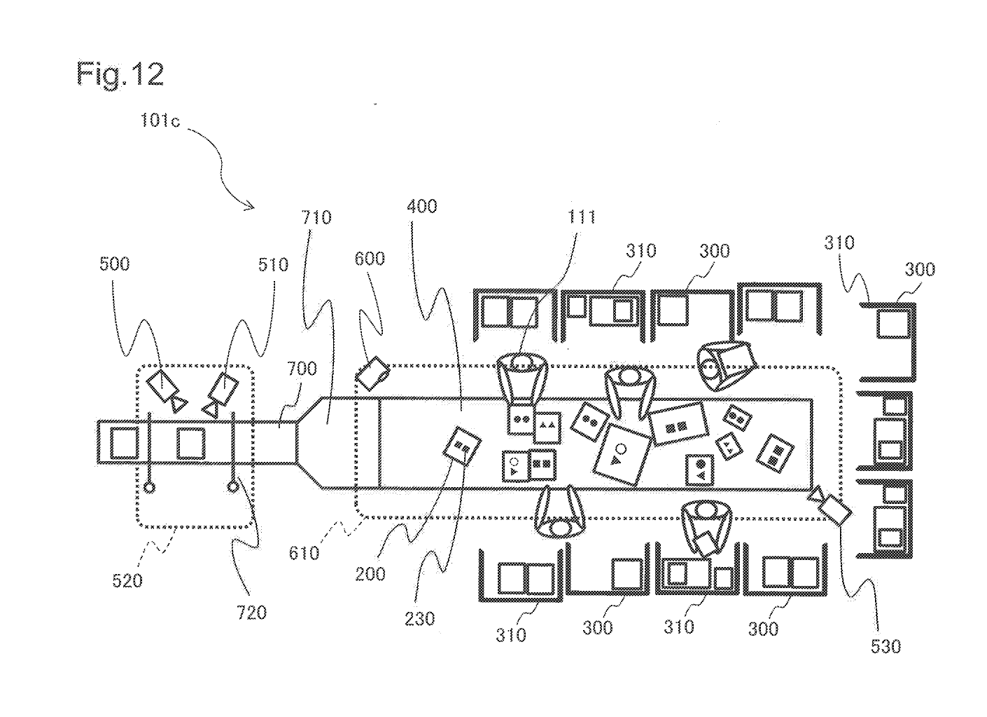

FIG. 12 is a diagram representing an information processing system according to the fourth exemplary embodiment and a distribution system including the information processing system. In the fourth exemplary embodiment, the information processing system 100 has a configuration of measuring a three-dimensional shape of the sorting object 200 in addition to the configuration of the first exemplary embodiment. The configuration that measures the three-dimensional shape of the sorting object 200 is included in the recognition device 520.

Specifically, the recognition device 520 includes a camera (for example, a camera with depth sensor) 510 capable of measuring the three-dimensional shape of the sorting object 200. As a method of measuring the three-dimensional shape, a method of obtaining a dimension in a height direction by processing the image of a measurement object (the sorting object 200) captured by a camera from a plurality of angles may be used. Moreover, the dimension in the height direction of the sorting object 200 can be acquired by using a combination of a camera and a distance sensor. A plurality of methods may be used as a method of measuring the three-dimensional shape of the sorting object 200. An appropriate method is selected as the method used in the recognition device 520 by taking the operation mode or the like of the sorting operator 111 into consideration.

The control device 620 of the projection device 610 adjusts the focusing of the sorting destination projection image 230 to be projected to an upper surface, for example, of the sorting object 200 using the height information of the sorting object 200 acquired by the recognition device 520. For example, a plurality of projectors 600 of which the focal positions of projection images are different is provided. The control device 620 selects the projector 600 of which the focusing point of the projection image is aligned on the upper surface, for example, of the sorting object 200 among the projectors 600 based on the height information of the sorting object 200. Moreover, the control device 620 controls the selected projector 600 to project the sorting destination projection image 230.

Further, in the fourth exemplary embodiment, a gate 720 that controls the entrance to a recognition area in which the recognition device 520 recognizes the sorting object 200 is provided. The opening of the gate 720 is controlled by the control device 550 by taking the capturing operation of the camera 500 or the like into consideration, for example.

The configurations other than the above-described configuration in the information processing system 100 of the fourth exemplary embodiment and the distribution system 101c including the information processing system 100 are the same as those of the first exemplary embodiment, and the description thereof will not be provided.

Since the information processing system 100 and the distribution system 101c of the fourth exemplary embodiment have the same configurations as those of the information processing system 100 of the first exemplary embodiment, the same advantages as those of the first exemplary embodiment can be obtained. Further, in the fourth exemplary embodiment, the information processing system 100 and the distribution system 101c have a configuration capable of measuring the dimension in the height direction of the sorting object 200 and adjusting the focusing of the sorting destination projection image 230 projected to the sorting object 200 based on the height dimension. Thus, the information processing system 100 and the distribution system 101c enable to prevent blurring of the sorting destination projection image 230 projected to the upper surface, for example, of the sorting object 200 due to a height fluctuation of the sorting object 200. That is, the information processing system 100 and the distribution system 101c enable to project the sorting destination projection image 230 to the upper surface of the sorting object 200 in a focused state regardless of fluctuation of the height of the sorting object 200. With this clear sorting destination projection image 230, the sorting operator 111 can recognize the sorting destination 300 of the sorting object 200 more easily. As a result, the sorting operator 111 can further decrease sorting errors.

### Fifth Exemplary Embodiment

Hereinafter, a fifth exemplary embodiment of the present invention will be described.

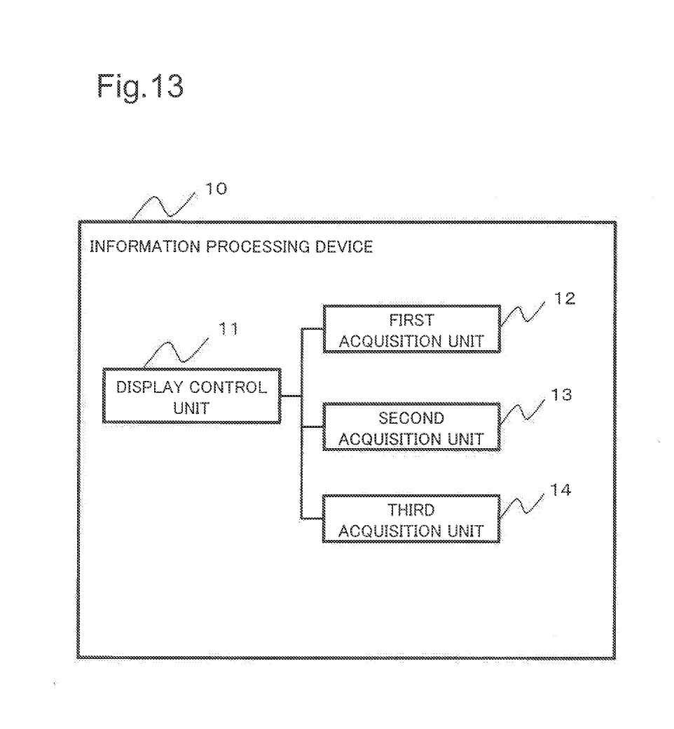

FIG. 13 is a block diagram illustrating a simplified configuration of an information processing device according to the fifth exemplary embodiment. The information processing device 10 of the fifth exemplary embodiment includes a display control unit 11, a first acquisition unit 12, a second acquisition unit 13 and a third acquisition unit 14. The first acquisition unit 12 has a function of acquiring a content described in the description associated with a processing object. The second acquisition unit 13 has a function of acquiring a position of the processing object. The third acquisition unit 14 has a function of acquiring rules that are correlated with the content described in the description and the operation content. The display control unit 11 has a function of outputting a signal representing the operation content for the processing object based on the content acquired by the first acquisition unit 12 and the rules acquired by the third acquisition unit 14.

The information processing device 10 acquires the content described in the description associated with the processing object, acquires the position of the processing object, and acquires the rules that are correlated with the content described in the description and the operation content. Moreover, the information processing device 10 performs control of displaying the operation content for the processing object based on the acquired content and the acquired rules. Thus, the information processing device 10 enables the operation content for the processing object to be notified clearly. In this way, the information processing device 10 enables the efficiency of operations on the processing object to be improved easily.

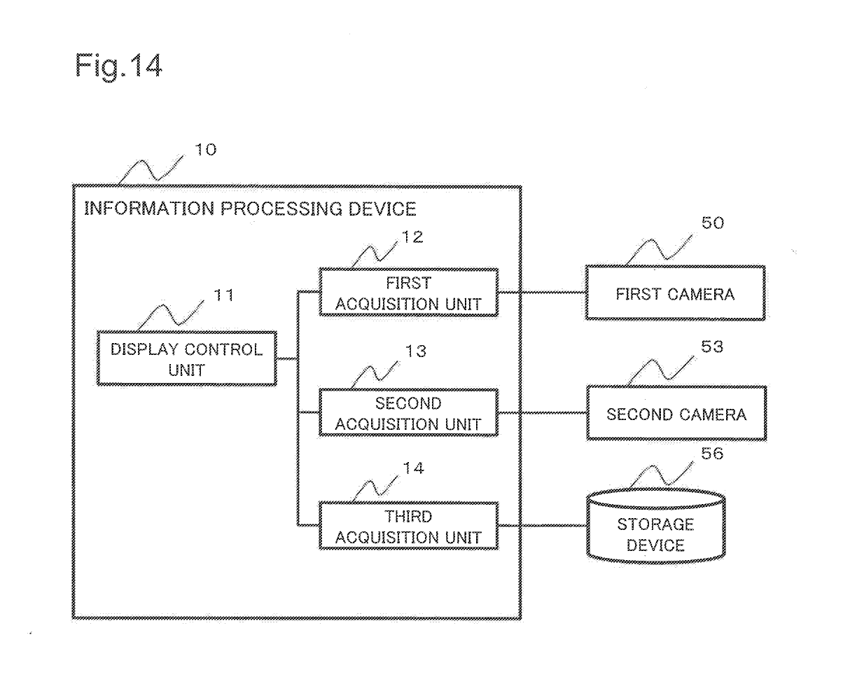

Here, a specific example of the information processing device 10 will be described. FIG. 14 is a block diagram representing a specific example of the information processing device 10. In the example of FIG. 14, the first acquisition unit 12 is connected to a first camera 50. The first acquisition unit 12 acquires information (for example, the content described in the description associated with the processing object) including the image (still image or moving image) captured by the first camera 50. The second acquisition unit 13 is connected to a second camera 53. The second acquisition unit 13 acquires information (for example, the position of the processing object) including the image (still image or moving image) captured by the second camera 53. The third acquisition unit 14 is connected directly or indirectly to a storage device 56. The third acquisition unit 14 acquires the information stored in the storage device 56 directly or indirectly. The display control unit 11 is connected to a display device (not illustrated) that displays information. The display control unit 11 controls the display device based on the information acquired by the acquisition units 12, 13, and 14.

The first acquisition unit 12, the second acquisition unit 13 and the third acquisition unit 14 may be configured as a single acquisition unit. Moreover, this single acquisition unit may communicate (transmit and receive) information with an external device.

Moreover, comparing the configurations illustrated in FIG. 14 with the system configurations described in the first to fourth exemplary embodiments, the first camera 50 and the second camera 53 illustrated in FIG. 14 correspond to the camera 500 and the camera 530 of the first to fourth exemplary embodiments, respectively. The storage device 56 corresponds to the database 560 of the first to fourth exemplary embodiments. The first acquisition unit 12 corresponds to the control device 550 of the first to fourth exemplary embodiments. Moreover, the second acquisition unit 13, the third acquisition unit 14 and the display control unit 11 correspond to the control device 620 of the first to fourth exemplary embodiments. Further, the device that displays information corresponds to the projector 600, for example.

The information processing device 10 may be provided in a wearable terminal, for example. A wearable terminal is a computer that a person can carry with the computer attached to the body thereof. Specifically, the information processing device 10 is incorporated into a glasses-type wearable terminal. This glasses-type wearable terminal is equipped on an operator so that the operation content can be displayed (projected) on the processing object processed by the operator or the vicinity thereof.

### Sixth Exemplary Embodiment

Hereinafter, a sixth exemplary embodiment of the present invention will be described.

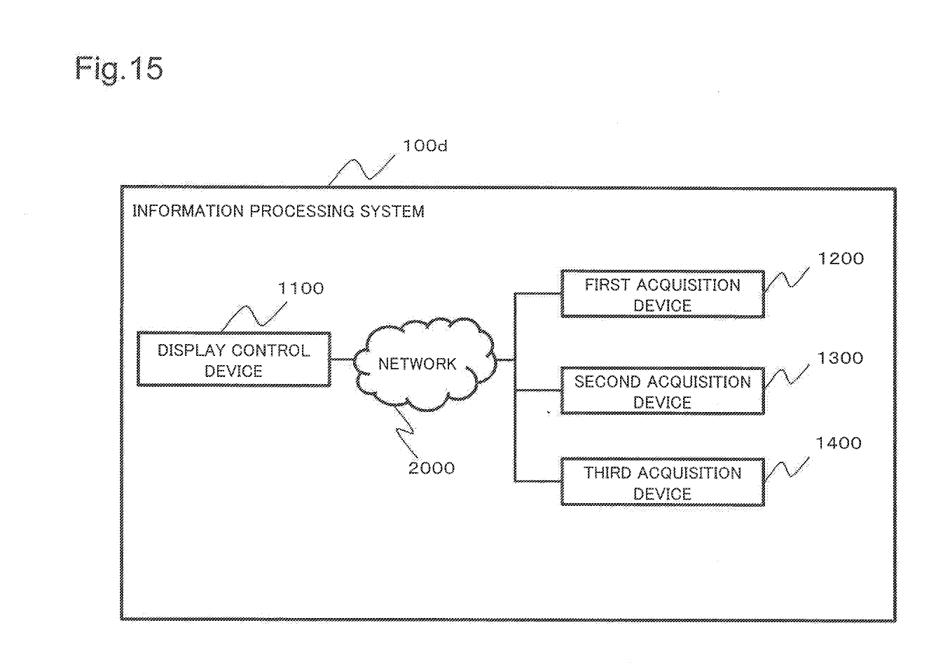

FIG. 15 is a diagram representing an information processing system according to the sixth exemplary embodiment. The information processing system 100d of the sixth exemplary embodiment includes a first acquisition device 1200, a second acquisition device 1300, a third acquisition device 1400 and a display control device 1100. The first acquisition device 1200 has a function of acquiring the content described in a description associated with a processing object. The second acquisition device 1300 has a function of acquiring a position of the processing object. The third acquisition device 1400 has a function of acquiring rules that are correlated with the content described in the description and the operation content. The display control device 1100 has a function of displaying the operation content for the processing object based on the content acquired by the first acquisition device 1200 and the rules acquired by the third acquisition device 1400.

The information processing system 100d of the sixth exemplary embodiment enables to improve the operation efficiency similarly to the respective exemplary embodiments.

In the example of FIG. 15, the first to third acquisition devices 1200, 1300, and 1400 and the display control device 1100 are connected via a network 2000.

When the information processing system 100d of the sixth exemplary embodiment is compared with the information processing systems of the first to fourth exemplary embodiments, the display control device 1100 of the sixth exemplary embodiment corresponds to the control devices 550 and 620 of the first to fourth exemplary embodiments. Moreover, the first acquisition device 1200 of the sixth exemplary embodiment corresponds to the camera 500 of the first to fourth exemplary embodiments. Further, the second acquisition device 1300 of the sixth exemplary embodiment corresponds to the camera 530 and the control device 620 of the first to fourth exemplary embodiments. Further, the third acquisition device 1400 of the sixth exemplary embodiment corresponds to the control device 620 of the first to fourth exemplary embodiments.

The display control device 1100 of the information processing system 100d may be incorporated into a wearable terminal, for example. Examples of the wearable terminal to which the display control device 1100 is incorporated include a glasses-type wearable terminal, an attachment-type (cap-attachment-type) wearable terminal attached to the cap visor, a wrist watch-type wearable terminal, a tablet-type wearable terminal that hangs on the neck, and a garment-type wearable terminal directly attached to a garment. However, the present invention is not limited to this. The respective devices that form the information processing system 100d may be different wearable terminals. That is, the information processing system 100d may be configured as a plurality of wearable terminal.

Here, an example of a display control method of the information processing system 100d in which respective devices are configured as wearable terminal will be described below.

When the display control device 1100 of the information processing system 100d is incorporated into a tablet-type, a wrist watch-type, or a garment-type wearable terminal, the display control device 1100 displays the operation content to the vicinity of the processing object. The display control device 1100 may display the operation content to a portion (for example, the arm holding the processing object) of the body of the sorting operator.

When the display control device 1100 of the information processing system 100d is incorporated into a cap-attachment type or a glasses-type wearable terminal, the operation content can be displayed in the following manner. For example, a projection plate (for example, a glasses lens) is disposed near the eyes of the sorting operator and the display control device 1100 displays the operation content on the projection plate. In this case, the display control device 1100 controls the display position of the operation content so that the operation content displayed on the glasses lens is visible in the vicinity of the processing object. Moreover, the display control device 1100 may be configured to display the operation content directly in the retina of the eyes of the sorting operator.

While the present invention has been described with reference to the exemplary embodiments, the present invention is not limited to the above-described exemplary embodiments. Various changes understandable by those skilled in the art may be made to the configuration and details of the present invention within the scope thereof.

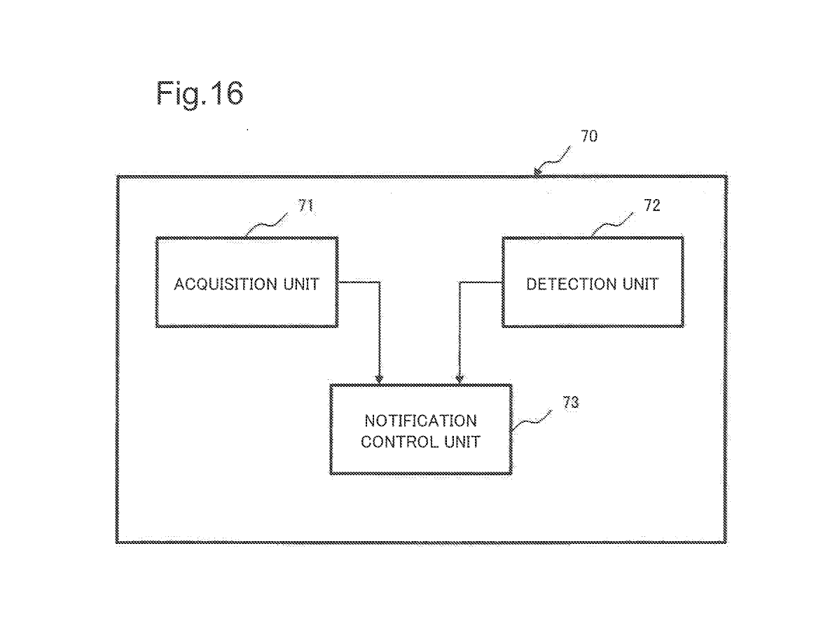

For example, the information processing device according to the present invention may have such a configuration as illustrated in FIG. 16. For example, an information processing device 70 illustrated in FIG. 16 includes an acquisition unit 71, a detection unit 72, and a notification control unit 73. The acquisition unit 71 has a function of acquiring information used for an operation executed on the processing object from a document associated with a processing object. The detection unit 72 has a function of detecting a location of the processing object. The notification control unit 73 has a function of detecting an operation content for the processing object based on the information used for the operation and rules which are data correlated with the operation content which uses the information. Further, the notification control unit 73 has a function of notifying the operation content by controlling the notification device that notifies the operation content. For example, the notification control unit 73 notifies the operation content by projecting an image representing the operation content to the processing object or the vicinity thereof.

Moreover, in the first to fourth exemplary embodiments, the slip attached to the sorting object 200 is described as an example of the document associated with the processing object. In contrast, the document associated with the processing object is not limited to the slip attached to the sorting object 200 but may be a tag attached to the sorting object 200, for example. However, since a position and a direction of the tag are likely to change, when information is acquired using an image captured by the camera from the tag as the document associated with the processing object, it is preferable to use the following method in order to acquire the information, for example. For example, the same information may be described on both sides of the tag. Alternatively, an operator performs an operation of adjusting the direction of the tag so that the surface (the surface on which information is described) of the tag is captured by the camera before the tag is captured by the camera.

This application is based upon and claims the benefit of priority from Japanese patent application No. 2014-067358, filed on Mar. 28, 2014, the disclosure of which is incorporated herein in its entirety by reference.

Some or all of the exemplary embodiments may be described as the following supplementary notes, but the present invention is not limited to these supplementary notes.

[Supplementary Note 1]

An information processing system includes:

a first acquisition device that acquires a content described in a description associated with a processing object;

a second acquisition device that acquires a position of the processing object;

a third acquisition device that acquires rules that are correlated with the content described in the description and an operation content; and

a display control device that outputs a signal to display the operation content for the processing object based on the content acquired by the first acquisition device and the rules acquired by the third acquisition device.

[Supplementary Note 2]

The information processing system according to Supplementary Note 1, further includes:

a display device that displays the operation content for the processing object to the processing object or the vicinity thereof based on the signal output from the display control device.

[Supplementary Note 3]

The information processing system according to Supplementary Note 1 or 2, wherein the operation content is displayed by allowing the processing object to exhibit colors.

[Supplementary Note 4]

The information processing system according to Supplementary Note 1, wherein the processing object is visible via a glasses lens, and

the display control device displays the operation content at a position on the glasses lens corresponding to the position of the processing object or the vicinity thereof.

[Supplementary Note 5]

An information processing system includes:

a first acquisition device that detects a content described in a description associated with a processing object;

a second acquisition device that detects a position of the processing object;

a storage device that records the content described in the description and an operation content; and

a display control device that displays the operation content for the processing object at the position of the processing object or the vicinity thereof based on the content detected by the first acquisition device and the information stored in the storage device.

[Supplementary Note 6]

The information processing system according to any one of Supplementary Notes 1 to 5, further includes an image projection device,

wherein the image projection device projects the operation content for the processing object to the position of the processing object or the vicinity thereof and changes a projection content according to movement of the processing object.

[Supplementary Note 7]

The information processing system according to any one of Supplementary Notes 1 to 6, wherein the display control device displays information including a destination of the processing object as the operation content.

[Supplementary Note 8]

The information processing system according to Supplementary Note 7, wherein the display control device displays a direction determined based on a relative position of the processing object in relation to the destination.

[Supplementary Note 9]

The information processing system according to any one of Supplementary Notes 1 to 8, wherein the display control device displays a direction determined based on the processing object and an operation position and an operation state of an operator who performs the operation content.

[Supplementary Note 10]

The information processing system according to any one of Supplementary Notes 1 to 9, wherein the display control device displays an attribute of the processing object.

[Supplementary Note 11]

The information processing system according to any one of Supplementary Notes 1 to 10, further includes a moving device that moves the processing object,

wherein the moving device is controlled based on one or both of the position and the number of the processing objects obtained by the second acquisition device.

[Supplementary Note 12]

The information processing system according to any one of Supplementary Notes 7 to 11, wherein the display control device displays information based on the content of the description at the position of the processing object or the vicinity thereof and the destination of the processing object.

[Supplementary Note 13]

The information processing system according to any one of Supplementary Notes 7 to 12, wherein the display control device stops displaying information on the destination of the processing object at a time point at which the position cannot be acquired by the second acquisition device or when a predetermined period has elapsed from the time point.

[Supplementary Note 14]

The information processing system according to any one of Supplementary Notes 1 to 13, further includes a fourth acquisition device that detects a shape of the processing object,

wherein the display control device displays the information based on the description at the position of the processing object or the vicinity thereof according to the position and the shape of the processing object.

[Supplementary Note 15]

An information processing device includes:

a first acquisition unit that acquires a content described in a description associated with a processing object;

a second acquisition unit that acquires a position of the processing object;

a third acquisition unit that acquires rules that are correlated with the content described in the description and an operation content; and

a display control unit that outputs a signal to display the operation content for the processing object based on the content acquired by the first acquisition unit and the rules acquired by the third acquisition unit.

[Supplementary Note 16]

An information processing method includes:

acquiring a content described in a description associated with a processing object;

acquiring a position of the processing object;

acquiring rules that are correlated with the content described in the description and an operation content; and

outputting a signal to display the operation content for the processing object based on the acquired content of the description and the rules.

[Supplementary Note 17]

A computer program for causing a computer to execute:

a process of acquiring a content described in a description associated with a processing object;

a process of acquiring a position of the processing object;

a process of acquiring rules that are correlated with the content described in the description and an operation content; and

a process of outputting a signal to display the operation content for the processing object based on the acquired content of the description and the rules.

### REFERENCE SIGNS LIST

100: Information processing system
101, 101a, 101b, 101c: Distribution system
200: Sorting object
210: Destination label
230: Sorting destination projection image
500, 530: Camera
520: Recognition device
550, 620: Control device
560: Database
600: Projector
610: Projection device
700: Conveying device

What is claimed is:

1. An information processing device comprising:
an acquisition unit that acquires information on an operation executed on a processing object from a document associated with the processing object;
a detection unit that detects a position of the processing object; and
a notification control unit that detects an operation content for the processing object based on rules which are data correlated with the information on the operation and the operation content which uses the information, and notifying the operation content by controlling a notification device that notifies the operation content.

2. The information processing device according to claim 1,
Wherein, based on data correlated with the position of the processing object and the content notified by the notification device, the notification control unit changes the content notified by the notification device according to a change in the position of the processing object detected by the detection unit.

3. The information processing device according to claim 1,
wherein when a predetermined period has elapsed after the detection unit detects the processing object, the notification control unit changes the content notified by the notification device according to the elapsed time.

4. The information processing device according to claim 1,
wherein the detection unit is configured to detect the position of the processing object in a detection area, and
the notification control unit performs control on the notification device so as to stop a notification operation for the processing object at a time point at which the position of the processing object is not detected by the detection unit or when a predetermined period has elapsed after the time point.

5. The information processing device according to claim 1,
wherein the notification control unit notifies the operation content by allowing a projection device which is the notification device to project the operation content to a surface of the processing object or the vicinity of the processing object.

6. An information processing system comprising:
an information processing device;
an information acquisition device that provides information representing a content of a document to an acquisition unit;
an information providing device that provides information on a position of a processing object to a detection unit; and
a notification device,
the information processing device comprising:
the acquisition unit that acquires information on an operation executed on the processing object from the document associated with the processing object;
the detection unit that detects the position of the processing object; and
a notification control unit that detects an operation content for the processing object based on rules which are data correlated with the information on the operation and the operation content which uses the information, and notifying the operation content by controlling the notification device that notifies the operation content.

7. The information processing system according to claim 6,
wherein the notification device is configured as a projection device, and
the projection device is incorporated into a device mounted on the head of an operator who processes the processing object so as to project an image representing the operation content to the vicinity of the eyes of the operator.

8. A distribution system comprising an information processing system,
the information processing system comprising:
an information processing device;
an information acquisition device that provides information representing a content of a document to an acquisition unit;
an information providing device that provides information on a position of a processing object to a detection unit; and
a notification device,
the information processing device comprising:
the acquisition unit that acquires information on an operation executed on the processing object from the document associated with the processing object;
the detection unit that detects the position of the processing object; and
a notification control unit that detects an operation content for the processing object based on rules which are data correlated with the information on the operation and the operation content which uses the information, and notifying the operation content by controlling the notification device that notifies the operation content,
wherein the notification device notifies a sorting destination to which the processing object is sorted as information representing the operation content for the processing object.

9. The distribution system according to claim 8, further comprising:
a conveying device that conveys the processing object; and
a conveyance control device that controls driving of the conveying device according to one or both of the position and the number of processing objects to be conveyed.

10. The distribution system according to claim 8,
wherein the notification device is a projection device, and
the notification control unit projects an image representing the sorting destination to which the processing object is sorted to the sorting destination as well as the processing object.

11. An information processing method for causing a computer to execute:
acquiring information on an operation executed on a processing object from a document associated with the processing object;
detecting an operation content for the processing object based on rules which are data correlated with the information on the operation and the operation content which uses the information; and
notifying the operation content.

12. A non-transitory program storage medium storing a computer program for causing a computer to execute:
a process of acquiring information on an operation executed on a processing object from a document associated with the processing object;
a process of detecting a position of the processing object;
a process of detecting an operation content for the processing object based on rules which are data correlated with the information on the operation and the operation content which uses the information; and
a process of notifying the operation content.
